(19) United States
(12) Patent Application Publication
(10) Pub. No.: US 2025/0333349 A1
(43) Pub. Date: Oct. 30, 2025

(54) Aluminosilicate Glasses with High Er3+ Concentration and High Quantum Yield

(71) Applicant: CORNING INCORPORATED, CORNING, NY (US)

(72) Inventors: Matthew John Dejneka, Corning, NY (US); Jorge Alberto Holguin Lerma, Corning, NY (US); Jason Edward Hurley, Corning, NY (US); Adam Robert Sarafian, Corning, NY (US)

(21) Appl. No.: 19/184,298

(22) Filed: Apr. 21, 2025

Related U.S. Application Data
(60) Provisional application No. 63/639,006, filed on Apr. 26, 2024.

(51) Int. Cl. C03C 13/04; C03C 3/095; C03C 3/11; C03C 3/112; C03C 3/118; C03C 4/12; G02B 6/02

(52) U.S. Cl. CPC C03C 13/046; C03C 3/095; C03C 3/11; C03C 3/111; C03C 3/112; C03C 3/118; C03C 4/12; G02B 6/02395; C03C 2204/00; C03C 2213/00

(57) ABSTRACT

Glasses with high Er₂O₃ concentration that exhibit low concentration quenching and low hydroxyl quenching of the emission of Er³⁺ near 1550 nm are described. The glasses include Al₂O₃ and optically non-interfering lanthanide components to disperse Er₂O₃ to minimize clustering of Er³⁺ ions as the concentration of Er₂O₃ in the glass composition increases to mitigate concentration quenching. Hydroxyl quenching is mitigated by calcining the batch components before melting and including a reducing agent in the batch composition. Optical fibers with cores made from the glasses exhibit high gain, low bending loss, and uniform gain across the C-band.

This application claims the benefit of priority to U.S. Provisional Patent Application Ser. No. 63/639,006 filed on Apr. 26, 2024, the content of which is relied upon and incorporated herein by reference in its entirety.

### FIELD

This description pertains to aluminosilicate glasses with high concentrations of Er³⁺. More specifically, this description pertains to aluminosilicate glasses with high quantum yield at high Er³⁺ concentrations. Most specifically, this description pertains to Er³⁺-doped aluminosilicate glasses that enable fiber amplifiers with high gain over short lengths.

### BACKGROUND

Erbium-doped fiber amplifiers (EDFA) commonly include glass fibers drawn from glass compositions that are doped with erbium ions (Er³⁺). The Er³⁺ ions exhibit luminescence in the near infrared (⁴I_{13/2}→⁴I_{15/2} transition near 1550 nm) that is used to amplify optical signals of similar wavelength. Coherent transceivers for 400 G and 800 G baud rates have a very high loss from the encoding modulation and thus require a post amplifier to maintain sufficient signal strength. A typical erbium-doped fiber amplifier (EDFA) requires 4 m to 20 m of Er³⁺-doped fiber to achieve 20 dB to 30 dB of gain of the optical signal. To maintain compact networks, data center providers prefer that these post amplifiers fit in a transceiver. Since it is not possible to coil meters of erbium-doped fiber into the limited space available for a post amplifier inside a transceiver (e.g., 16×30 mm), erbium-doped fiber amplifiers (EDFA) higher gain per unit fiber length than is currently achievable are needed.

To increase the gain, a proportionate increase in the concentration of Er³⁺ ions in the glass composition used to form the fiber of the erbium-doped fiber amplifier (EDFA) is needed. However, it is well known that Er³⁺ suffers from appreciable concentration quenching at Er³⁺ concentrations above about 5×10¹⁹ Er³⁺ ions/cm³. The concentration quenching leads to a significant reduction in the quantum yield of Er³⁺ luminescence in the near infrared. As a result, the Er³⁺ concentration used in current erbium-doped fiber amplifiers (EDFA) is limited to well below 5×10¹⁹ Er³⁺ ions/cm³, which leads to diminished gain per unit fiber length in the erbium-doped fiber amplifier (EDFA) and the consequent need to extend the fiber length to achieve the gain needed for adequate signal amplification.

Hydroxyl quenching is a second mechanism that contributes to reduced quantum yield of Er³⁺ luminescence. Hydroxyl quenching is caused by the presence of water in the glass composition of the fiber. Vibrational energy of hydroxyl groups leads to non-radiative decay of the excited state (⁴I_{13/2}) of Er³⁺ and a loss of luminescence intensity.

There is accordingly a need for glasses with high Er³⁺ concentrations and high quantum yield to realize erbium-doped fiber amplifiers (EDFA) with high gain per unit fiber length and compact form factors.

### SUMMARY

The following disclosures describes Er³⁺-doped aluminosilicate glasses with high concentrations of Er³⁺. The glasses feature high quantum yield of Er³⁺ luminescence in the near infrared (⁴I_{13/2}→⁴I_{15/2} transition near 1550 nm). The high quantum yield is achieved by minimizing non-radiative quenching of Er³⁺ luminescence. Concentration quenching is reduced by minimizing clustering of Er³⁺ ions by incorporating other, optically non-interfering rare earth ions in the glass composition to spatially separate Er³⁺ ions. Hydroxyl quenching is minimized by reducing the water content of the glass. High Er³⁺ concentration is facilitated by incorporating Al₂O₃ into the glass composition to improve the solubility of Er³⁺. Through intermixing of Er³⁺ with other rare earth ions, removing water from the glass composition, and incorporating Al₂O₃ in the composition it becomes possible to achieve Er³⁺-doped glasses with high quantum yield. The glasses are amenable to fabrication in waveguide or fiber form factors to provide fiber amplifiers with high gain and low bend loss in compact deployment environments.

The present disclosure extends to:

A glass having a composition comprising:
66.0-95.0 mol. % SiO₂;
10.0-30.0 mol. % Al₂O₃;
0.0-2.0 mol. % B₂O₃;
0.0-20.0 mol. % Na₂O;
0.0-4.0 mol. % ZnO;
0.0-20.0 mol. % La₂O₃;
0.0-20.0 mol. % Y₂O₃;
0.0-3.5 mol. % Yb₂O₃;
0.1-5.0 mol. % Er₂O₃;
0.0-7.0 mol. % F;
wherein the composition satisfies the conditions:

$$1. \leq \frac{{Al}_{2} {O}_{3}}{{Y}_{2} {O}_{3} + {La}_{2} {O}_{3} + {Gd}_{2} {O}_{3} + {Er}_{2} {O}_{3} + {Yb}_{2} {O}_{3} + {Lu}_{2} {O}_{3}} \leq 20.$$

$$0.1 \leq {Y}_{2} {O}_{3} + {La}_{2} {O}_{3} + {Gd}_{2} {O}_{3} + {Yb}_{2} {O}_{3} + {Lu}_{2} {O}_{3} \leq 20. 0 .$$

The present disclosure extends to:

A glass having a composition comprising:
66.0-87.0 mol. % SiO₂;
3.0-30.0 mol. % Al₂O₃;
0.0-25.0 mol. % Na₂O;
0.0-2.0 mol. % ZnO;
0.0-25.0 mol. % La₂O₃;
0.0-25.0 mol. % Y₂O₃;
0.0-3.5 mol. % Yb₂O₃;
0.1-5.0 mol. % Er₂O₃;
wherein the composition satisfies the condition:

$$1.1 \leq \frac{{Al}_{2} {O}_{3}}{\begin{matrix}{Y}_{2} {O}_{3} + {La}_{2} {O}_{3} + {Gd}_{2} {O}_{3} + {Yb}_{2} {O}_{3} + {Lu}_{2} {O}_{3} + {Li}_{2} O + {Na}_{2} O \\ + {K}_{2} O\end{matrix}} \leq 11.0 .$$

The present disclosure extends to:

A glass having a composition comprising:
63.0-95.0 mol. % SiO₂;
0.1-30.0 mol. % Al₂O₃;
0.0-2.0 mol. % B₂O₃;
0.0-25.0 mol. % Na₂O;
0.0-3.0 mol. % ZnO;
0.0-25.0 mol. % La₂O₃;
0.0-25.0 mol. % Y₂O₃;
0.0-10.0 mol. % Yb₂O₃;
0.5-10.0 mol. % Er₂O₃;
0.0-7.0 mol. % F;
wherein the composition satisfies the conditions:

$$1. < \frac{{Al}_{2} {O}_{3}}{{Y}_{2} {O}_{3} + {La}_{2} {O}_{3} + {Gd}_{2} {O}_{3} + {Er}_{2} {O}_{3} + {Yb}_{2} {O}_{3} + {Lu}_{2} {O}_{3}} \leq 30.$$

$$0.1 \leq {Y}_{2} {O}_{3} + {La}_{2} {O}_{3} + {Gd}_{2} {O}_{3} + {Yb}_{2} {O}_{3} + {Lu}_{2} {O}_{3} \leq 30. .$$

$$1. \leq {Li}_{2} O + {Na}_{2} O + {K}_{2} O \leq 20. .$$

The present disclosure extends to:

A glass having a composition comprising:
61.0-95.0 mol. % SiO₂;
0.0-30.0 mol. % Al₂O₃;
0.0-2.0 mol. % B₂O₃;
0.0-30.0 mol. % Na₂O;
0.0-3.0 mol. % ZnO;
0.0-30.0 mol. % La₂O₃;
0.0-30.0 mol. % Y₂O₃;
0.0-10.0 mol. % Yb₂O₃;
0.5-10.0 mol. % Er₂O₃;
0.0-7.0 mol. % F;
wherein the composition satisfies the conditions:

$$0. \leq \frac{{Al}_{2} {O}_{3}}{{Y}_{2} {O}_{3} + {La}_{2} {O}_{3} + {Gd}_{2} {O}_{3} + {Er}_{2} {O}_{3} + {Yb}_{2} {O}_{3} + {Lu}_{2} {O}_{3}} \leq 30.$$

$$0.6 \leq \frac{{Y}_{2} {O}_{3} + {La}_{2} {O}_{3} + {Gd}_{2} {O}_{3} + {Yb}_{2} {O}_{3} + {Lu}_{2} {O}_{3}}{{Er}_{2} {O}_{3}} \leq 30. .$$

$$1. \leq {Li}_{2} O + {Na}_{2} O + {K}_{2} O \leq 30. .$$

The present disclosure extends to:

An optical fiber comprising:
a core, the core including a glass having a composition comprising:
   66.0-95.0 mol. % SiO₂;
   10.0-30.0 mol. % Al₂O₃;
   0.0-2.0 mol. % B₂O₃;
   0.0-20.0 mol. % Na₂O;
   0.0-4.0 mol. % ZnO;
   0.0-20.0 mol. % La₂O₃;
   0.0-20.0 mol. % Y₂O₃;
   0.0-3.5 mol. % Yb₂O₃;
   0.1-5.0 mol. % Er₂O₃;
   0.0-7.0 mol. % F;
wherein the composition satisfies the conditions:

$$1. \leq \frac{{Al}_{2} {O}_{3}}{{Y}_{2} {O}_{3} + {La}_{2} {O}_{3} + {Gd}_{2} {O}_{3} + {Er}_{2} {O}_{3} + {Yb}_{2} {O}_{3} + {Lu}_{2} {O}_{3}} \leq 20.$$

$$0.1 \leq {Y}_{2} {O}_{3} + {La}_{2} {O}_{3} + {Gd}_{2} {O}_{3} + {Yb}_{2} {O}_{3} + {Lu}_{2} {O}_{3} \leq 20. ;$$

and a cladding, the cladding surrounding and directly adjacent the core, the cladding comprising silica glass.

The present disclosure extends to:

An optical fiber comprising:
a core, the core including a glass having a composition comprising:
   66.0-87.0 mol. % SiO₂;
   3.0-30.0 mol. % Al₂O₃;
   0.0-25.0 mol. % Na₂O;
   0.0-2.0 mol. % ZnO;
   0.0-25.0 mol. % La₂O₃;
   0.0-25.0 mol. % Y₂O₃;
   0.0-3.5 mol. % Yb₂O₃;
   0.1-5.0 mol. % Er₂O₃;
wherein the composition satisfies the condition:

$$1.1 \leq \frac{{Al}_{2} {O}_{3}}{\begin{matrix}{Y}_{2} {O}_{3} + {La}_{2} {O}_{3} + {Gd}_{2} {O}_{3} + {Yb}_{2} {O}_{3} + {Lu}_{2} {O}_{3} + {Li}_{2} O + {Na}_{2} O \\ + {K}_{2} O\end{matrix}} \leq 11. ;$$

and a cladding, the cladding surrounding and directly adjacent the core, the cladding comprising silica glass.

The present disclosure extends to:

An optical fiber comprising:
a core, the core including a glass having a composition comprising:
   63.0-95.0 mol. % SiO₂;
   0.1-30.0 mol. % Al₂O₃;
   0.0-2.0 mol. % B₂O₃;
   0.0-25.0 mol. % Na₂O;
   0.0-3.0 mol. % ZnO;
   0.0-25.0 mol. % La₂O₃;
   0.0-25.0 mol. % Y₂O₃;
   0.0-10.0 mol. % Yb₂O₃;
   0.5-10.0 mol. % Er₂O₃;
   0.0-7.0 mol. % F;
wherein the composition satisfies the conditions:

$$0. < \frac{{Al}_{2} {O}_{3}}{{Y}_{2} {O}_{3} + {La}_{2} {O}_{3} + {Gd}_{2} {O}_{3} + {Er}_{2} {O}_{3} + {Yb}_{2} {O}_{3} + {Lu}_{2} {O}_{3}} \leq 30.$$

$$0.1 \leq {Y}_{2} {O}_{3} + {La}_{2} {O}_{3} + {Gd}_{2} {O}_{3} + {Yb}_{2} {O}_{3} + {Lu}_{2} {O}_{3} \leq 30.$$

$$1. \leq {Li}_{2} O + {Na}_{2} O + {K}_{2} O \leq 20. ;$$

and a cladding, the cladding surrounding and directly adjacent the core, the cladding comprising silica glass.

The present disclosure extends to:

An optical fiber comprising:
a core, the core including a glass having a composition comprising:
   61.0-95.0 mol. % SiO₂;
   0.0-30.0 mol. % Al₂O₃;
   0.0-2.0 mol. % B₂O₃;
   0.0-30.0 mol. % Na₂O;
   0.0-3.0 mol. % ZnO;
   0.0-30.0 mol. % La₂O₃;
   0.0-30.0 mol. % Y₂O₃;
   0.0-10.0 mol. % Yb₂O₃;
   0.5-10.0 mol. % Er₂O₃;
   0.0-7.0 mol. % F;
wherein the composition satisfies the conditions:

$$0. \leq \frac{{Al}_{2} {O}_{3}}{{Y}_{2} {O}_{3} + {La}_{2} {O}_{3} + {Gd}_{2} {O}_{3} + {Er}_{2} {O}_{3} + {Yb}_{2} {O}_{3} + {Lu}_{2} {O}_{3}} \leq 30.$$

$$0.6 \leq \frac{{Y}_{2} {O}_{3} + {La}_{2} {O}_{3} + {Gd}_{2} {O}_{3} + {Yb}_{2} {O}_{3} + {Lu}_{2} {O}_{3}}{{Er}_{2} {O}_{3}} \leq 30.$$

$$1. \leq {Li}_{2} O + {Na}_{2} O + {K}_{2} O \leq 30. ;$$

and a cladding, the cladding surrounding and directly adjacent the core, the cladding comprising silica glass.

The present disclosure extends to:

A method for forming a glass comprising:
melting a batch of glass components, the batch comprising
   SiO₂;
   Al₂O₃;
   Er₂O₃;
   at least one of Y₂O₃, La₂O₃, Gd₂O₃, Yb₂O₃, and Lu₂O₃, and
   a reducing agent.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification serve to explain principles and operation of methods, products, and compositions embraced by the present description. Features shown in the drawing are illustrative of selected embodiments of the present description and are not necessarily depicted in proper scale.

### BRIEF DESCRIPTION OF THE DRAWINGS

While the specification concludes with claims particularly pointing out and distinctly claiming the subject matter of the written description, it is believed that the specification will be better understood from the following written description when taken in conjunction with the accompanying drawings, wherein:

FIG. 1 shows quantum yield QY (%) as a function of β_{OH} (mm⁻¹) for several examples of Er₂O₃-containing glasses having an Er³⁺ ion concentration above 1.0×10¹⁹/cm³.

FIG. 2 shows quantum yield QY (%) as a function of Er³⁺ ion concentration (×10¹⁸/cm³) several Er₂O₃-containing glasses having an Er³⁺ ion concentration above 1.0×10¹⁹/cm³.

FIG. 3 shows the refractive index profile of an exemplary optical fiber.

FIG. 4 shows absolute gain as a function of pump power for different lengths of an exemplary optical fiber.

FIG. 5 shows the variation in absolute gain as a function of signal wavelength for an exemplary optical fiber and a comparative optical fiber.

FIG. 6 shows the raw bit error ratio of a fiber span with and without an exemplary optical fiber.

FIG. 7 shows the bend performance of a comparative and exemplary optical fiber.

The embodiments set forth in the drawings are illustrative in nature and not intended to be limiting of the scope of the detailed description or claims. Whenever possible, the same reference numeral will be used throughout the drawings to refer to the same or like feature.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including, without limitation, matters of logic with respect to arrangement of steps or operational flow; plain meaning derived from grammatical organization or punctuation; the number or type of embodiments described in the specification.

In this specification and in the claims which follow, reference will be made to a number of terms which shall be defined to have the following meanings:

The term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Values expressed as ranges include the endpoints of the range. For example, if a glass is said to have a composition comprising “66.0 mol. % to 90.0 mol. % SiO₂”, the intended compositions include those with greater than or equal to 66.0 mol. % SiO₂ and less than or equal to 90.0 mol. % SiO₂.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those skilled in the art. When the term “about” is used in describing a value or an endpoint of a range, the disclosure should be understood to include the specific value or endpoint referred to.

The term “component” refers to a material or compound included in a batch composition from which a glass is formed. Representative components include oxides such as B₂O₃, Al₂O₃, Li₂O, K₂O, Na₂O, Cs₂O, MgO, CaO, BaO, SiO₂, ZnO, Y₂O₃, Yb₂O₃, La₂O₃, Er₂O₃, Gd₂O₃, Lu₂O₃, Y₂O₃, etc. Other representative components include halogens (e.g., F, Br, Cl).

Whenever a component is included as a term in a mathematical expression or formula, it is understood that the component refers to the amount of the component in units of mol. % in the batch composition of the glass. For example, the expression “Y₂O₃+Er₂O₃” refers to the sum of the amount of Y₂O₃ in units of mol. % and the amount of Er₂O₃ in units of mol. % in the batch composition of the glass. A mathematical expression or formula is any expression or formula that includes a mathematical operator such as “+”, “−”, “*”, or

Unless otherwise specified, the amount, concentration, or content of a component in a glass composition is expressed herein in units of mol. % (mole percent).

The term “rare earth” (RE) refers to the elements listed in the Lanthanide Series of the IUPAC Periodic Table, plus yttrium. The term “RE₂O₃” is used to refer to the total concentration of rare earth oxides. The difference RE₂O₃−Er₂O₃ refers to the total concentration of rare earth oxides other than Er₂O₃.

The terms “luminescence” or “emission” when used in reference to Er³⁺ refers to the luminescence or emission of light due to an electronic transition from the ⁴I_{13/2} excited state of Er³⁺ to the ⁴I_{15/2} ground state of Er³⁺. The luminescence of Er³⁺ occurs in the near infrared portion of the electromagnetic spectrum and appears as a spectral band located near 1550 nm.

The term “quantum yield” refers to the ratio of the number of photons emitted by Er³⁺ in the ⁴I_{13/2}→⁴I_{15/2} emission band to the number of photons used to excite Er³⁺. As is known in the art, the ⁴I_{13/2}→⁴I₁₅/2 emission band is located in the near-infrared spectral region (near 1550 nm). For purposes of the present disclosure, the ⁴I_{13/2}→⁴I_{15/2} emission band of Er³⁺ is produced by exciting the ⁴I_{15/2}→⁴I_{11/2} transition of Er³⁺ at a pump wavelength of 980 nm. The quantum yield thus refers to the ratio of photons emitted by Er³⁺ in the spectral band associated with the ⁴I_{13/2}→⁴I_{15/2} emission to the number of photons at 980 nm used to excite Er³⁺ from the ⁴I_{51/2} ground state to the ⁴I_{11/2} excited state. In the examples disclosed herein, quantum yield was measured with an integrating sphere using techniques known in the art (see “FLS980 Series Reference Guide—Integrating Sphere for Measurements of Fluorescence Quantum Yields and Spectral Reflectance” (revision 1, copyrighted 2016) by Edinburgh Instruments Ltd., Livingston UK) and is expressed in units of %. By way of example, a quantum yield of 100% means that each photon absorbed by Er³⁺ at 980 nm produces a photon of emission of Er³⁺ in the ⁴I_{13/2}→⁴I_{15/2} emission band.

The quantity “β_{OH}” is a measure of the hydroxyl content of a glass. It corresponds to a ratio of the peak absorption intensity of the hydroxyl (—OH) vibrational band in the infrared (near 3500 cm⁻¹), corrected for baseline absorption, to the path length of the incident beam through the glass. The path length is typically the thickness of the sample. β_{OH} is expressed herein in units of reciprocal mm (mm⁻¹ or/mm) and was measured using a spectrophotometer.

Reference will now be made in detail to illustrative embodiments of the present description.

The glasses disclosed herein are Er³⁺-doped silicate glasses that exhibit high quantum yield at Er³⁺ doping concentrations above 10²⁰ Er³⁺ ions/cm³. The glasses include a high concentration of Al₂O₃ to increase the solubility of Er₂O₃ to promote a high doping concentration of Er³⁺ ions and to promote the incorporation of oxides of optically non-interfering rare earth ions (e.g., y³⁺, La³⁺, Yb³⁺, Lu³⁺, Gd³⁺). As used herein, an optically non-interfering rare earth ion is a rare earth ion that does not absorb emission of Er³⁺ or the pump wavelength used to excite Er³⁺. The purpose of the optically non-interfering rare earth ions is to intermix with Er³⁺ to inhibit the clustering of Er³⁺ that leads to concentration quenching through energy transfer between Er³⁺ ions. The intermixing reduces concentration quenching of Er³⁺ emission by increasing the average distance between Er³⁺ ions in the glass. It is well known that rare earth ions can cluster in silicate glasses at high concentrations. By keeping the amount of optically non-interfering rare earth ions greater than the Er³⁺ ion concentration, if a cluster with an Er³⁺ ion were to form, it would be more likely to be clustered with an optically non-interfering rare earth ion which does not result in quenching as opposed to an Er³⁺ ion clustered with another Er³⁺ ions which does result in quenching.

The glasses further include low hydroxyl (OH) concentration and accordingly exhibit low values of β_{OH} to minimize hydroxyl quenching of Er³⁺ emission. The low hydroxyl content is achieved by including reducing agents in addition to the glass components when batching the glass. Reducing agents include elemental Si, Al metal, silicon nitride (Si₃N₄), and aluminum nitride (AlN). The reducing agents act to convert hydroxyl groups in the batch to network oxygen and H₂ gas, where the H₂ gas is liberated from the glass during processing.

Preferred compositions for the glasses and fibers formed from the glasses are now described. Methods of making the glasses and the fibers are next described and followed by a series of illustrative examples.

### Glass Compositions

The concentration of SiO₂ in the glasses or fibers formed from the glasses is greater than or equal to 50.0 mol. %, or greater than or equal to 55.0 mol. %, or greater than or equal to 60.0 mol. %, or greater than or equal to 62.0 mol. %, or greater than or equal to 64.0 mol. %, or greater than or equal to 66.0 mol. %, or greater than or equal to 68.0 mol. %, or greater than or equal to 70.0 mol. %, or greater than or equal to 75.0 mol. %, or greater than or equal to 80.0 mol. %, or greater than or equal to 85.0 mol. %, or greater than or equal to 90.0 mol. %, or in the range from 55.0 mol. % to 95.0 mol. %, or in the range from 60.0 mol. % to 95.0 mol. %, or in the range from 61.0 mol. % to 95.0 mol. %, or in the range from 62.0 mol. % to 95.0 mol. %, or in the range from 63.0 mol. % to 95.0 mol. %, or in the range from 65.0 mol. % to 95.0 mol. %, or in the range from 66.0 mol. % to 95.0 mol. %, or in the range from 60.0 mol. % to 90.0 mol. %, or in the range from 61.0 mol. % to 90.0 mol. %, or in the range from 62.0 mol. % to 90.0 mol. %, or in the range from 63.0 mol. % to 90.0 mol. %, or in the range from 64.0 mol. % to 90.0 mol. %, or in the range from 66.0 mol. % to 90.0 mol. %, or in the range from 68.0 mol. % to 90.0 mol. %, or in the range from 68.0 mol. % to 87.5 mol. %, or in the range from 66.0 mol. % to 87.0 mol. %, or in the range from 60.0 mol. % to 85.0 mol. %, in the range from 62.0 mol. % to 85.0 mol. %, or in the range from 64.0 mol. % to 85.0 mol. %, or in the range from 66.0 mol. % to 85.0 mol. %, or in the range from 68.0 mol. % to 85.0 mol. %, or in the range from 70.0 mol. % to 85.0 mol. %, or in the range from 60.0 mol. % to 80.0 mol. %, or in the range from 62.0 mol. % to 80.0 mol. %, or in the range from 64.0 mol. % to 80.0 mol. %, or in the range from 66.0 mol. % to 80.0 mol. %, or in the range from 68.0 mol. % to 80.0 mol. %, or in the range from 60.0 mol. % to 75.0 mol. %, or in the range from 62.0 mol. % to 75.0 mol. %, or in the range from 64.0 mol. % to 75.0 mol. %, or in the range from 66.0 mol. % to 75.0 mol. %, or in the range from 68.0 mol. % to 75.0 mol. %, or in the range from 60.0 mol. % to 70.0 mol. %, or in the range from 62.0 mol. % to 70.0 mol. %, or in the range from 64.0 mol. % to 70.0 mol. %, or in the range from 66.0 mol. % to 70.0 mol. %, or in the range from 68.0 mol. % to 70.0 mol. %.

The concentration of Al₂O₃ in the glasses or fibers formed from the glasses is greater than or equal to 0.0 mol. %, or greater than or equal to 0.1 mol. %, or greater than or equal to 0.5 mol. %, or greater than or equal to 1.0 mol. %, or greater than or equal to 2.5 mol. %, or greater than or equal to 5.0 mol. %, or greater than or equal to 10.0 mol. %, or greater than or equal to 12.5 mol. %, or greater than or equal to 15.0 mol. %, or greater than or equal to 17.5 mol. %, or greater than or equal to 20.0 mol. %, or greater than or equal to 22.5 mol. %, or greater than or equal to 25.0 mol. %, or greater than or equal to 27.5 mol. %, or in the range from 0.0 mol. % to 30.0 mol. %, or in the range from 0.1 mol. % to 30.0 mol. %, or in the range from 0.5 mol. % to 30.0 mol. %, or in the range from 1.0 mol. % to 30.0 mol. %, or in the range from 2.5 mol. % to 30.0 mol. %, or in the range from 3.0 mol. % to 30.0 mol. %, or in the range from 5.0 mol. % to 30.0 mol. %, or in the range from 7.5 mol. % to 30.0 mol. %, or in the range from 10.0 mol. % to 30.0 mol. %, or in the range from 15.0 mol. % to 30.0 mol. %, or in the range from 20.0 mol. % to 30.0 mol. %, or in the range from 12.5 mol. % to 27.5 mol. %, in the range from 15.0 mol. % to 27.5 mol. %, or in the range from 17.5 mol. % to 27.5 mol. %, or in the range from 20.0 mol. % to 27.5 mol. %, or in the range from 12.5 mol. % to 25.0 mol. %, or in the range from 15.0 mol. % to 25.0 mol. %, or in the range from 17.5 mol. % to 25.0 mol. %, or in the range from 20.0 mol. % to 25.0 mol. %, or in the range from 10.0 mol. % to 22.5 mol. %, or in the range from 12.5 mol. % to 22.5 mol. %, or in the range from 15.0 mol. % to 22.5 mol. %, or in the range from 10.0 mol. % to 20.0 mol. %, or in the range from 12.5 mol. % to 20.0 mol. %.

The concentration of Er₂O₃ in the glasses or fibers formed from the glasses is greater than or equal to 0.05 mol. %, or greater than or equal to 0.1 mol. %, or greater than or equal to 0.2 mol. %, or greater than or equal to 0.5 mol. %, or greater than or equal to 1.0 mol. %, or greater than or equal to 1.5 mol. %, or greater than or equal to 2.0 mol. %, or greater than or equal to 2.5 mol. %, or greater than or equal to 3.0 mol. %, or greater than or equal to 3.5 mol. %, or greater than or equal to 4.0 mol. %, or greater than or equal to 4.5 mol. %, or greater than or equal to 5.0 mol. %, or greater than or equal to 6.0 mol. %, or greater than or equal to 8.0 mol. %, or in the range from 0.05 mol. % to 10.0 mol. %, or in the range from 0.1 mol. % to 10.0 mol. %, or in the range from 0.2 mol. % to 10.0 mol. %, or in the range from 0.5 mol. % to 10.0 mol. %, or in the range from 1.0 mol. % to 10.0 mol. %, or in the range from 1.5 mol. % to 10.0 mol. %, or in the range from 2.0 mol. % to 10.0 mol. %, or in the range from 2.5 mol. % to 10.0 mol. %, or in the range from 3.0 mol. % to 30.0 mol. %, or in the range from 0.05 mol. % to 5.0 mol. %, or in the range from 0.1 mol. % to 5.0 mol. %, in the range from 0.2 mol. % to 5.0 mol. %, or in the range from 0.5 mol. % to 5.0 mol. %, or in the range from 1.0 mol. % to 5.0 mol. %, or in the range from 1.5 mol. % to 5.0 mol. %, or in the range from 1.5 mol. % to 5.0 mol. %, or in the range from 2.5 mol. % to 5.0 mol. %, or in the range from 3.0 mol. % to 5.0 mol. %, or in the range from 0.1 mol. % to 4.0 mol. %, or in the range from 0.2 mol. % to 4.0 mol. %, or in the range from 0.5 mol. % to 4.0 mol. %, or in the range from 1.0 mol. % to 4.0 mol. %, or in the range from 1.5 mol. % to 4.0 mol. %.

The concentration of rare earth oxides other than Er₂O₃, individually or in combination, in the glasses or fibers formed from the glasses is greater than or equal to 0.05 mol. %, or greater than or equal to 0.1 mol. %, or greater than or equal to 0.5 mol. %, or greater than or equal to 1.0 mol. %, or greater than or equal to 2.5 mol. %, or greater than or equal to 5.0 mol. %, or greater than or equal to 7.5 mol. %, or greater than or equal to 10.0 mol. %, or greater than or equal to 12.5 mol. %, or greater than or equal to 15.0 mol. %, or greater than or equal to 17.5 mol. %, or greater than or equal to 20.0 mol. %, or greater than or equal to 22.5 mol. %, or greater than or equal to 25.0 mol. %, or greater than or equal to 27.5 mol. %, or in the range from 0.05 mol. % to 30.0 mol. %, or in the range from 0.1 mol. % to 30.0 mol. %, or in the range from 0.5 mol. % to 30.0 mol. %, or in the range from 1.0 mol. % to 30.0 mol. %, or in the range from 2.5 mol. % to 30.0 mol. %, or in the range from 5.0 mol. % to 30.0 mol. %, or in the range from 10.0 mol. % to 30.0 mol. %, or in the range from 15.0 mol. % to 30.0 mol. %, or in the range from 20.0 mol. % to 30.0 mol. %, or in the range from 0.05 mol. % to 25.0 mol. %, or in the range from 0.1 mol. % to 25.0 mol. %, or in the range from 0.5 mol. % to 25.0 mol. %, or in the range from 1.0 mol. % to 25.0 mol. %, or in the range from 2.5 mol. % to 25.0 mol. %, or in the range from 5.0 mol. % to 25.0 mol. %, or in the range from 10.0 mol. % to 25.0 mol. %, or in the range from 15.0 mol. % to 25.0 mol. %, or in the range from 20.0 mol. % to 25.0 mol. %, or in the range from 0.05 mol. % to 20.0 mol. %, or in the range from 0.1 mol. % to 20.0 mol. %, or in the range from 0.5 mol. % to 20.0 mol. %, or in the range from 1.0 mol. % to 20.0 mol. %, or in the range from 2.5 mol. % to 20.0 mol. %, or in the range from 5.0 mol. % to 20.0 mol. %, or in the range from 10.0 mol. % to 20.0 mol. %, or in the range from 15.0 mol. % to 20.0 mol. %.

The concentration of Y₂O₃, La₂O₃, Gd₂O₃, Yb₂O₃, Lu₂O₃, individually or in combination, in the glasses or fibers formed from the glasses is greater than or equal to 0.0 mol. %, or greater than or equal to 0.05 mol. %, or greater than or equal to 0.1 mol. %, or greater than or equal to 0.5 mol. %, or greater than or equal to 1.0 mol. %, or greater than or equal to 2.5 mol. %, or greater than or equal to 5.0 mol. %, or greater than or equal to 7.5 mol. %, or greater than or equal to 10.0 mol. %, or greater than or equal to 12.5 mol. %, or greater than or equal to 15.0 mol. %, or greater than or equal to 17.5 mol. %, or greater than or equal to 20.0 mol. %, or greater than or equal to 22.5 mol. %, or greater than or equal to 25.0 mol. %, or greater than or equal to 27.5 mol. %, or in the range from 0.0 mol. % to 30.0 mol. %, or in the range from 0.05 mol. % to 30.0 mol. %, or in the range from 0.1 mol. % to 30.0 mol. %, or in the range from 0.5 mol. % to 30.0 mol. %, or in the range from 1.0 mol. % to 30.0 mol. %, or in the range from 2.5 mol. % to 30.0 mol. %, or in the range from 5.0 mol. % to 30.0 mol. %, or in the range from 10.0 mol. % to 30.0 mol. %, or in the range from 15.0 mol. % to 30.0 mol. %, or in the range from 20.0 mol. % to 30.0 mol. %, or in the range from 0.0 mol. % to 25.0 mol. %, or in the range from 0.05 mol. % to 25.0 mol. %, or in the range from 0.1 mol. % to 25.0 mol. %, or in the range from 0.5 mol. % to 25.0 mol. %, or in the range from 1.0 mol. % to 25.0 mol. %, or in the range from 2.5 mol. % to 25.0 mol. %, or in the range from 5.0 mol. % to 25.0 mol. %, or in the range from 10.0 mol. % to 25.0 mol. %, or in the range from 15.0 mol. % to 25.0 mol. %, or in the range from 20.0 mol. % to 25.0 mol. %, or in the range from 0.0 mol. % to 20.0 mol. %, or in the range from 0.05 mol. % to 20.0 mol. %, or in the range from 0.1 mol. % to 20.0 mol. %, or in the range from 0.5 mol. % to 20.0 mol. %, or in the range from 1.0 mol. % to 20.0 mol. %, or in the range from 2.5 mol. % to 20.0 mol. %, or in the range from 5.0 mol. % to 20.0 mol. %, or in the range from 10.0 mol. % to 20.0 mol. %, or in the range from 15.0 mol. % to 20.0 mol. %, or in the range from 0.0 mol. % to 15.0 mol. %, or in the range from 0.05 mol. % to 15.0 mol. %, or in the range from 0.1 mol. % to 15.0 mol. %, or in the range from 0.5 mol. % to 15.0 mol. %, or in the range from 1.0 mol. % to 15.0 mol. %, or in the range from 2.5 mol. % to 15.0 mol. %, or in the range from 5.0 mol. % to 15.0 mol. %, or in the range from 10.0 mol. % to 15.0 mol. %, or in the range from 0.0 mol. % to 10.0 mol. %, or in the range from 0.05 mol. % to 10.0 mol. %, or in the range from 0.1 mol. % to 10.0 mol. %, or in the range from 0.5 mol. % to 10.0 mol. %, or in the range from 1.0 mol. % to 10.0 mol. %, or in the range from 2.5 mol. % to 10.0 mol. %, or in the range from 5.0 mol. % to 10.0 mol. %, or in the range from 0.0 mol. % to 5.0 mol. %, or in the range from 0.05 mol. % to 5.0 mol. %, or in the range from 0.1 mol. % to 5.0 mol. %, or in the range from 0.5 mol. % to 5.0 mol. %, or in the range from 1.0 mol. % to 5.0 mol. %, or in the range from 2.5 mol. % to 5.0 mol. %, or in the range from 0.0 mol. % to 3.5 mol. %, or in the range from 0.0 mol. % to 2.0 mol. %. In some embodiments, the glass includes some, but not all of Y₂O₃, La₂O₃, Gd₂O₃, Yb₂O₃, and Lu₂O₃; that is, the glass lacks one, two, three or four of Y₂O₃, La₂O₃, Gd₂O₃, Yb₂O₃, and Lu₂O₃.

The sum of Y₂O₃+La₂O₃+Gd₂O₃+Yb₂O₃+Lu₂O₃ in the glasses or fibers formed from the glasses is greater than or equal to 0.05 mol. %, or greater than or equal to 0.1 mol. %, or greater than or equal to 0.5 mol. %, or greater than or equal to 1.0 mol. %, or greater than or equal to 2.5 mol. %, or greater than or equal to 5.0 mol. %, or greater than or equal to 7.5 mol. %, or greater than or equal to 10.0 mol. %, or greater than or equal to 12.5 mol. %, or greater than or equal to 15.0 mol. %, or greater than or equal to 17.5 mol. %, or greater than or equal to 20.0 mol. %, or greater than or equal to 22.5 mol. %, or greater than or equal to 25.0 mol. %, or greater than or equal to 27.5 mol. %, or in the range from 0.05 mol. % to 30.0 mol. %, or in the range from 0.1 mol. % to 30.0 mol. %, or in the range from 0.5 mol. % to 30.0 mol. %, or in the range from 1.0 mol. % to 30.0 mol. %, or in the range from 2.5 mol. % to 30.0 mol. %, or in the range from 5.0 mol. % to 30.0 mol. %, or in the range from 10.0 mol. % to 30.0 mol. %, or in the range from 15.0 mol. % to 30.0 mol. %, or in the range from 20.0 mol. % to 30.0 mol. %, or in the range from 0.05 mol. % to 25.0 mol. %, or in the range from 0.1 mol. % to 25.0 mol. %, or in the range from 0.5 mol. % to 25.0 mol. %, or in the range from 1.0 mol. % to 25.0 mol. %, or in the range from 2.5 mol. % to 25.0 mol. %, or in the range from 5.0 mol. % to 25.0 mol. %, or in the range from 10.0 mol. % to 25.0 mol. %, or in the range from 15.0 mol. % to 25.0 mol. %, or in the range from 20.0 mol. % to 25.0 mol. %, or in the range from 0.05 mol. % to 20.0 mol. %, or in the range from 0.1 mol. % to 20.0 mol. %, or in the range from 0.5 mol. % to 20.0 mol. %, or in the range from 1.0 mol. % to 20.0 mol. %, or in the range from 2.5 mol. % to 20.0 mol. %, or in the range from 5.0 mol. % to 20.0 mol. %, or in the range from 10.0 mol. % to 20.0 mol. %, or in the range from 15.0 mol. % to 20.0 mol. %, or in the range from 0.05 mol. % to 15.0 mol. %, or in the range from 0.1 mol. % to 15.0 mol. %, or in the range from 0.5 mol. % to 15.0 mol. %, or in the range from 1.0 mol. % to 15.0 mol. %, or in the range from 2.5 mol. % to 15.0 mol. %, or in the range from 5.0 mol. % to 15.0 mol. %, or in the range from 10.0 mol. % to 15.0 mol. %, or in the range from 0.1 mol. % to 15.0 mol. %, or in the range from 0.5 mol. % to 15.0 mol. %, or in the range from 1.0 mol. % to 15.0 mol. %, or in the range from 2.5 mol. % to 15.0 mol. %, or in the range from 5.0 mol. % to 15.0 mol. %, or in the range from 10.0 mol. % to 15.0 mol. %, or in the range from 0.0 mol. % to 10.0 mol. %, or in the range from 0.05 mol. % to 10.0 mol. %, or in the range from 0.1 mol. % to 10.0 mol. %, or in the range from 0.5 mol. % to 10.0 mol. %, or in the range from 1.0 mol. % to 10.0 mol. %, or in the range from 2.5 mol. % to 10.0 mol. %, or in the range from 5.0 mol. % to 10.0 mol. %.

The concentration of Li₂O in the glasses or fibers formed from the glasses is greater than or equal to 0.0 mol. %, or greater than or equal to 0.1 mol. %, or greater than or equal to 0.5 mol. %, or greater than or equal to 1.0 mol. %, or greater than or equal to 2.5 mol. %, or greater than or equal to 5.0 mol. %, or greater than or equal to 10.0 mol. %, or greater than or equal to 12.5 mol. %, or greater than or equal to 15.0 mol. %, or greater than or equal to 17.5 mol. %, or greater than or equal to 20.0 mol. %, or greater than or equal to 22.5 mol. %, or greater than or equal to 25.0 mol. %, or greater than or equal to 27.5 mol. %, or in the range from 0.0 mol. % to 30.0 mol. %, or in the range from 0.1 mol. % to 30.0 mol. %, or in the range from 0.5 mol. % to 30.0 mol. %, or in the range from 1.0 mol. % to 30.0 mol. %, or in the range from 2.5 mol. % to 30.0 mol. %, or in the range from 5.0 mol. % to 30.0 mol. %, or in the range from 7.5 mol. % to 30.0 mol. %, or in the range from 10.0 mol. % to 30.0 mol. %, or in the range from 12.5 mol. % to 27.5 mol. %, in the range from 15.0 mol. % to 27.5 mol. %, or in the range from 17.5 mol. % to 27.5 mol. %, or in the range from 20.0 mol. % to 27.5 mol. %, or in the range from 5.0 mol. % to 25.0 mol. %, or in the range from 10.0 mol. % to 25.0 mol. %, or in the range from 12.5 mol. % to 25.0 mol. %, or in the range from 15.0 mol. % to 25.0 mol. %, or in the range from 17.5 mol. % to 25.0 mol. %, or in the range from 20.0 mol. % to 25.0 mol. %, or in the range from 10.0 mol. % to 22.5 mol. %, or in the range from 12.5 mol. % to 22.5 mol. %, or in the range from 15.0 mol. % to 22.5 mol. %, or in the range from 5.0 mol. % to 20.0 mol. %, or in the range from 7.5 mol. % to 20.0 mol. %, or in the range from 10.0 mol. % to 20.0 mol. %, or in the range from 12.5 mol. % to 20.0 mol. % or in the range from 5.0 mol. % to 15.0 mol. %, or in the range from 7.5 mol. % to 17.5 mol. %.

The concentration of Na₂O in the glasses or fibers formed from the glasses is greater than or equal to 0.0 mol. %, or greater than or equal to 0.1 mol. %, or greater than or equal to 0.5 mol. %, or greater than or equal to 1.0 mol. %, or greater than or equal to 2.5 mol. %, or greater than or equal to 5.0 mol. %, or greater than or equal to 10.0 mol. %, or greater than or equal to 12.5 mol. %, or greater than or equal to 15.0 mol. %, or greater than or equal to 17.5 mol. %, or greater than or equal to 20.0 mol. %, or greater than or equal to 22.5 mol. %, or greater than or equal to 25.0 mol. %, or greater than or equal to 27.5 mol. %, or in the range from 0.0 mol. % to 30.0 mol. %, or in the range from 0.1 mol. % to 30.0 mol. %, or in the range from 0.5 mol. % to 30.0 mol. %, or in the range from 1.0 mol. % to 30.0 mol. %, or in the range from 2.5 mol. % to 30.0 mol. %, or in the range from 5.0 mol. % to 30.0 mol. %, or in the range from 7.5 mol. % to 30.0 mol. %, or in the range from 10.0 mol. % to 30.0 mol. %, or in the range from 12.5 mol. % to 27.5 mol. %, in the range from 15.0 mol. % to 27.5 mol. %, or in the range from 17.5 mol. % to 27.5 mol. %, or in the range from 20.0 mol. % to 27.5 mol. %, or in the range from 5.0 mol. % to 25.0 mol. %, or in the range from 10.0 mol. % to 25.0 mol. %, or in the range from 12.5 mol. % to 25.0 mol. %, or in the range from 15.0 mol. % to 25.0 mol. %, or in the range from 17.5 mol. % to 25.0 mol. %, or in the range from 20.0 mol. % to 25.0 mol. %, or in the range from 10.0 mol. % to 22.5 mol. %, or in the range from 12.5 mol. % to 22.5 mol. %, or in the range from 15.0 mol. % to 22.5 mol. %, or in the range from 5.0 mol. % to 20.0 mol. %, or in the range from 7.5 mol. % to 20.0 mol. %, or in the range from 10.0 mol. % to 20.0 mol. %, or in the range from 12.5 mol. % to 20.0 mol. % or in the range from 5.0 mol. % to 15.0 mol. %, or in the range from 7.5 mol. % to 17.5 mol. %.

The concentration of K₂O in the glasses or fibers formed from the glasses is greater than or equal to 0.0 mol. %, or greater than or equal to 0.1 mol. %, or greater than or equal to 0.5 mol. %, or greater than or equal to 1.0 mol. %, or greater than or equal to 2.5 mol. %, or greater than or equal to 5.0 mol. %, or greater than or equal to 10.0 mol. %, or greater than or equal to 12.5 mol. %, or greater than or equal to 15.0 mol. %, or greater than or equal to 17.5 mol. %, or greater than or equal to 20.0 mol. %, or greater than or equal to 22.5 mol. %, or greater than or equal to 25.0 mol. %, or greater than or equal to 27.5 mol. %, or in the range from 0.0 mol. % to 30.0 mol. %, or in the range from 0.1 mol. % to 30.0 mol. %, or in the range from 0.5 mol. % to 30.0 mol. %, or in the range from 1.0 mol. % to 30.0 mol. %, or in the range from 2.5 mol. % to 30.0 mol. %, or in the range from 5.0 mol. % to 30.0 mol. %, or in the range from 7.5 mol. % to 30.0 mol. %, or in the range from 10.0 mol. % to 30.0 mol. %, or in the range from 12.5 mol. % to 27.5 mol. %, in the range from 15.0 mol. % to 27.5 mol. %, or in the range from 17.5 mol. % to 27.5 mol. %, or in the range from 20.0 mol. % to 27.5 mol. %, or in the range from 5.0 mol. % to 25.0 mol. %, or in the range from 10.0 mol. % to 25.0 mol. %, or in the range from 12.5 mol. % to 25.0 mol. %, or in the range from 15.0 mol. % to 25.0 mol. %, or in the range from 17.5 mol. % to 25.0 mol. %, or in the range from 20.0 mol. % to 25.0 mol. %, or in the range from 10.0 mol. % to 22.5 mol. %, or in the range from 12.5 mol. % to 22.5 mol. %, or in the range from 15.0 mol. % to 22.5 mol. %, or in the range from 5.0 mol. % to 20.0 mol. %, or in the range from 7.5 mol. % to 20.0 mol. %, or in the range from 10.0 mol. % to 20.0 mol. %, or in the range from 12.5 mol. % to 20.0 mol. % or in the range from 5.0 mol. % to 15.0 mol. %, or in the range from 7.5 mol. % to 17.5 mol. %.

The sum of Li₂O+Na₂O+K₂O in the glasses or fibers formed from the glasses is greater than or equal to 0.0 mol. %, or greater than or equal to 0.1 mol. %, or greater than or equal to 0.5 mol. %, or greater than or equal to 1.0 mol. %, or greater than or equal to 2.5 mol. %, or greater than or equal to 5.0 mol. %, or greater than or equal to 10.0 mol. %, or greater than or equal to 12.5 mol. %, or greater than or equal to 15.0 mol. %, or greater than or equal to 17.5 mol. %, or greater than or equal to 20.0 mol. %, or greater than or equal to 22.5 mol. %, or greater than or equal to 25.0 mol. %, or greater than or equal to 27.5 mol. %, or in the range from 0.0 mol. % to 30.0 mol. %, or in the range from 0.1 mol. % to 30.0 mol. %, or in the range from 0.5 mol. % to 30.0 mol. %, or in the range from 1.0 mol. % to 30.0 mol. %, or in the range from 2.5 mol. % to 30.0 mol. %, or in the range from 5.0 mol. % to 30.0 mol. %, or in the range from 7.5 mol. % to 30.0 mol. %, or in the range from 10.0 mol. % to 30.0 mol. %, or in the range from 0.0 mol. % to 27.5 mol. %, or in the range from 0.1 mol. % to 27.5 mol. %, or in the range from 0.5 mol. % to 27.5 mol. %, or in the range from 1.0 mol. % to 27.5 mol. %, or in the range from 12.5 mol. % to 27.5 mol. %, in the range from 15.0 mol. % to 27.5 mol. %, or in the range from 17.5 mol. % to 27.5 mol. %, or in the range from 20.0 mol. % to 27.5 mol. %, or in the range from 0.0 mol. % to 25.0 mol. %, or in the range from 0.1 mol. % to 25.0 mol. %, or in the range from 0.5 mol. % to 25.0 mol. %, or in the range from 1.0 mol. % to 25.0 mol. %, or in the range from 12.5 mol. % to 25.0 mol. %, or in the range from 15.0 mol. % to 25.0 mol. %, or in the range from 17.5 mol. % to 25.0 mol. %, or in the range from 20.0 mol. % to 25.0 mol. %, or in the range from 1.0 mol. % to 22.5 mol. %, or in the range from 10.0 mol. % to 22.5 mol. %, or in the range from 12.5 mol. % to 22.5 mol. %, or in the range from 15.0 mol. % to 22.5 mol. %, or in the range from 0.0 mol. % to 20.0 mol. %, or in the range from 0.1 mol. % to 20.0 mol. %, or in the range from 0.5 mol. % to 20.0 mol. %, or in the range from 1.0 mol. % to 20.0 mol. %, or in the range from 10.0 mol. % to 20.0 mol. %, or in the range from 12.5 mol. % to 20.0 mol. %, or in the range from 0.0 mol. % to 15.0 mol. %, or in the range from 0.1 mol. % to 15.0 mol. %, or in the range from 0.5 mol. % to 15.0 mol. %, or in the range from 1.0 mol. % to 15.0 mol. %, or in the range from 0.0 mol. % to 10.0 mol. %, or in the range from 0.1 mol. % to 10.0 mol. %, or in the range from 0.5 mol. % to 10.0 mol. %, or in the range from 1.0 mol. % to 10.0 mol. %.

The concentration of MgO in the glasses or fibers formed from the glasses is greater than or equal to 0.0 mol. %, or greater than or equal to 0.1 mol. %, or greater than or equal to 0.3 mol. %, or greater than or equal to 0.5 mol. %, or greater than or equal to 0.7 mol. %, or greater than or equal to 1.0 mol. %, or greater than or equal to 1.3 mol. %, or greater than or equal to 1.5 mol. %, or greater than or equal to 1.7 mol. %, or greater than or equal to 2.0 mol. %, or greater than or equal to 2.3 mol. %, or greater than or equal to 2.5 mol. %, or greater than or equal to 2.7 mol. %, or greater than or equal to 3.0 mol. %, or in the range from 0.0 mol. % to 5.0 mol. %, or in the range from 0.1 mol. % to 4.7 mol. %, or in the range from 0.2 mol. % to 4.5 mol. %, or in the range from 0.3 mol. % to 4.3 mol. %, or in the range from 0.4 mol. % to 4.0 mol. %, or in the range from 0.5 mol. % to 3.7 mol. %, or in the range from 0.6 mol. % to 3.5 mol. %, or in the range from 0.7 mol. % to 3.3 mol. %, or in the range from 0.8 mol. % to 3.0 mol. %, in the range from 0.9 mol. % to 2.7 mol. %, or in the range from 1.0 mol. % to 2.5 mol. %.

The concentration of CaO in the glasses or fibers formed from the glasses is greater than or equal to 0.0 mol. %, or greater than or equal to 0.1 mol. %, or greater than or equal to 0.5 mol. %, or greater than or equal to 1.0 mol. %, or greater than or equal to 2.5 mol. %, or greater than or equal to 5.0 mol. %, or greater than or equal to 10.0 mol. %, or greater than or equal to 12.5 mol. %, or greater than or equal to 15.0 mol. %, or greater than or equal to 17.5 mol. %, or greater than or equal to 20.0 mol. %, or greater than or equal to 22.5 mol. %, or greater than or equal to 25.0 mol. %, or in the range from 0.0 mol. % to 30.0 mol. %, or in the range from 0.1 mol. % to 27.5 mol. %, or in the range from 0.5 mol. % to 25.0 mol. %, or in the range from 1.0 mol. % to 22.5 mol. %, or in the range from 2.5 mol. % to 20.0 mol. %, or in the range from 5.0 mol. % to 17.5 mol. %, or in the range from 7.5 mol. % to 15.0 mol. %.

The concentration of SrO in the glasses or fibers formed from the glasses is greater than or equal to 0.0 mol. %, or greater than or equal to 0.1 mol. %, or greater than or equal to 0.3 mol. %, or greater than or equal to 0.5 mol. %, or greater than or equal to 0.7 mol. %, or greater than or equal to 1.0 mol. %, or greater than or equal to 1.5 mol. %, or greater than or equal to 2.0 mol. %, or greater than or equal to 2.5 mol. %, or greater than or equal to 3.0 mol. %, or greater than or equal to 3.5 mol. %, or greater than or equal to 4.0 mol. %, or greater than or equal to 4.5 mol. %, or greater than or equal to 5.0 mol. %, or in the range from 0.0 mol. % to 7.0 mol. %, or in the range from 0.1 mol. % to 6.5 mol. %, or in the range from 0.3 mol. % to 6.3 mol. %, or in the range from 0.5 mol. % to 6.0 mol. %, or in the range from 0.7 mol. % to 5.7 mol. %, or in the range from 1.0 mol. % to 5.5 mol. %, or in the range from 1.5 mol. % to 5.3 mol. %, or in the range from 2.0 mol. % to 5.0 mol. %, or in the range from 2.5 mol. % to 4.7 mol. %, in the range from 3.0 mol. % to 4.5 mol. %.

The sum of MgO+CaO+SrO in the glasses or fibers formed from the glasses is greater than or equal to 0.0 mol. %, or greater than or equal to 0.1 mol. %, or greater than or equal to 0.5 mol. %, or greater than or equal to 1.0 mol. %, or greater than or equal to 2.5 mol. %, or greater than or equal to 5.0 mol. %, or greater than or equal to 10.0 mol. %, or greater than or equal to 12.5 mol. %, or greater than or equal to 15.0 mol. %, or greater than or equal to 17.5 mol. %, or greater than or equal to 20.0 mol. %, or greater than or equal to 22.5 mol. %, or greater than or equal to 25.0 mol. %, or in the range from 0.0 mol. % to 30.0 mol. %, or in the range from 0.1 mol. % to 27.5 mol. %, or in the range from 0.5 mol. % to 25.0 mol. %, or in the range from 1.0 mol. % to 22.5 mol. %, or in the range from 2.5 mol. % to 20.0 mol. %, or in the range from 5.0 mol. % to 17.5 mol. %, or in the range from 7.5 mol. % to 15.0 mol. %.

The concentration of ZnO in the glasses or fibers formed from the glasses is greater than or equal to 0.0 mol. %, or greater than or equal to 0.1 mol. %, or greater than or equal to 0.2 mol. %, or greater than or equal to 0.3 mol. %, or greater than or equal to 0.5 mol. %, or greater than or equal to 0.7 mol. %, or greater than or equal to 1.0 mol. %, or greater than or equal to 1.2 mol. %, or greater than or equal to 1.5 mol. %, or greater than or equal to 1.7 mol. %, or greater than or equal to 2.0 mol. %, or greater than or equal to 2.5 mol. %, or greater than or equal to 3.0 mol. %, or greater than or equal to 3.5 mol. %, or in the range from 0.0 mol. % to 4.0 mol. %, or in the range from 0.1 mol. % to 4.0 mol. %, or in the range from 0.2 mol. % to 4.0 mol. %, or in the range from 0.3 mol. % to 4.0 mol. %, or in the range from 0.5 mol. % to 4.0 mol. %, or in the range from 0.7 mol. % to 4.0 mol. %, or in the range from 1.0 mol. % to 4.0 mol. %, or in the range from 1.5 mol. % to 4.0 mol. %, or in the range from 0.0 mol. % to 3.5 mol. %, or in the range from 0.1 mol. % to 3.5 mol. %, in the range from 0.2 mol. % to 3.5 mol. %, or in the range from 0.3 mol. % to 3.5 mol. %, or in the range from 0.5 mol. % to 3.5 mol. %, or in the range from 0.0 mol. % to 3.0 mol. %, or in the range from 0.1 mol. % to 3.0 mol. %, or in the range from 0.2 mol. % to 3.0 mol. %, or in the range from 0.3 mol. % to 3.0 mol. %, or in the range from 0.5 mol. % to 3.0 mol. %, or in the range from 0.0 mol. % to 2.5 mol. %, or in the range from 0.1 mol. % to 2.5 mol. %, or in the range from 0.2 mol. % to 2.5 mol. %, or in the range from 0.5 mol. % to 2.5 mol. %, or in the range from 0.0 mol. % to 2.0 mol. %, or in the range from 0.1 mol. % to 2.0 mol. %, or in the range from 0.2 mol. % to 2.0 mol. %, or in the range from 0.5 mol. % to 2.0 mol. %, or in the range from 0.0 mol. % to 1.0 mol. %, or in the range from 0.1 mol. % to 1.0 mol. %, or in the range from 0.2 mol. % to 1.0 mol. %, or in the range from 0.5 mol. % to 1.0 mol. %. In some embodiments, the glass lacks ZnO.

The concentration of B₂O₃ in the glasses or fibers formed from the glasses is greater than or equal to 0.0 mol. %, or greater than or equal to 0.1 mol. %, or greater than or equal to 0.2 mol. %, or greater than or equal to 0.3 mol. %, or greater than or equal to 0.5 mol. %, or greater than or equal to 0.7 mol. %, or greater than or equal to 1.0 mol. %, or greater than or equal to 1.2 mol. %, or greater than or equal to 1.5 mol. %, or greater than or equal to 1.7 mol. %, or in the range from 0.0 mol. % to 2.0 mol. %, or in the range from 0.1 mol. % to 2.0 mol. %, or in the range from 0.2 mol. % to 2.0 mol. %, or in the range from 0.3 mol. % to 2.0 mol. %, or in the range from 0.5 mol. % to 2.0 mol. %, or in the range from 0.7 mol. % to 2.0 mol. %, or in the range from 1.0 mol. % to 2.0 mol. %, or in the range from 1.2 mol. % to 2.0 mol. %, or in the range from 0.0 mol. % to 1.5 mol. %, or in the range from 0.1 mol. % to 1.5 mol. %, in the range from 0.2 mol. % to 1.5 mol. %, or in the range from 0.3 mol. % to 1.5 mol. %, or in the range from 0.5 mol. % to 1.5 mol. %, or in the range from 0.7 mol. % to 1.5 mol. %, or in the range from 1.0 mol. % to 1.5 mol. %, or in the range from 0.0 mol. % to 1.0 mol. %, or in the range from 0.1 mol. % to 1.0 mol. %. In some embodiments, the glass lacks B₂O₃.

In some embodiments, components of the glass composition are metal fluorides (e.g., NaF, Al₂F₆, REF₃ (where RE is a rare earth)). In such embodiments, glasses or fibers formed from the glasses may include fluorine (F), where the concentration of F is greater than or equal to 0.0 mol. %, or greater than or equal to 0.1 mol. %, or greater than or equal to 0.2 mol. %, or greater than or equal to 0.3 mol. %, or greater than or equal to 0.5 mol. %, or greater than or equal to 1.0 mol. %, or greater than or equal to 1.5 mol. %, or greater than or equal to 2.0 mol. %, or greater than or equal to 2.5 mol. %, or greater than or equal to 3.0 mol. %, or greater than or equal to 3.5 mol. %, or greater than or equal to 4.0 mol. %, or greater than or equal to 4.5 mol. %, or greater than or equal to 5.0 mol. %, or in the range from 0.0 mol. % to 7.0 mol. %, or in the range from 0.1 mol. % to 7.0 mol. %, or in the range from 0.2 mol. % to 7.0 mol. %, or in the range from 0.3 mol. % to 7.0 mol. %, or in the range from 0.5 mol. % to 7.0 mol. %, or in the range from 0.7 mol. % to 7.0 mol. %, or in the range from 1.0 mol. % to 7.0 mol. %, or in the range from 1.5 mol. % to 7.0 mol. %, or in the range from 0.0 mol. % to 5.0 mol. %, or in the range from 0.1 mol. % to 5.0 mol. %, in the range from 0.2 mol. % to 5.0 mol. %, or in the range from 0.3 mol. % to 5.0 mol. %, or in the range from 0.5 mol. % to 5.0 mol. %, or in the range from 0.0 mol. % to 3.0 mol. %, or in the range from 0.1 mol. % to 3.0 mol. %, or in the range from 0.2 mol. % to 3.0 mol. %, or in the range from 0.3 mol. % to 3.0 mol. %, or in the range from 0.5 mol. % to 3.0 mol. %, or in the range from 0.0 mol. % to 2.5 mol. %, or in the range from 0.1 mol. % to 2.5 mol. %, or in the range from 0.2 mol. % to 2.5 mol. %, or in the range from 0.5 mol. % to 2.5 mol. %. In some embodiments, the glass lacks F.

To promote solubility of rare earth oxides in the glass composition, it is preferably to have a high ratio of Al₂O₃ to RE₂O₃. In embodiments, the ratio Al₂O₃/RE₂O₃ is greater than or equal to 0.1, or greater than or equal to 0.5, or greater than or equal to 1.0, or greater than or equal to 1.5, or greater than or equal to 2.0, or greater than or equal to 3.0, or greater than or equal to 4.0, or greater than or equal to 5.0, or greater than or equal to 6.0, or greater than or equal to 8.0, or greater than or equal to 10.0, or greater than or equal to 15.0, or greater than or equal to 20.0, or in the range from 0.1 to 30.0, or in the range from 0.5 to 30.0, or in the range from 1.0 to 30.0, or in the range from 1.5 to 30.0, or in the range from 2.0 to 30.0, or in the range from 3.0 to 30.0, or in the range from 4.0 to 30.0, or in the range from 5.0 to 30.0, or in the range from 0.1 to 20.0, or in the range from 0.5 to 20.0, or in the range from 1.0 to 20.0, or in the range from 1.5 to 20.0, or in the range from 2.0 to 20.0, or in the range from 3.0 to 20.0, or in the range from 4.0 to 20.0, or in the range from 5.0 to 20.0, or in the range from 0.1 to 10.0, or in the range from 0.5 to 10.0, or in the range from 1.0 to 10.0, or in the range from 1.5 to 10.0, or in the range from 2.0 to 10.0, or in the range from 3.0 to 10.0, or in the range from 4.0 to 10.0, or in the range from 5.0 to 10.0.

In embodiments, the ratio Al₂O₃/(RE₂O₃— Er₂O₃) is greater than or equal to 0.1, or greater than or equal to 0.5, or greater than or equal to 1.0, or greater than or equal to 1.5, or greater than or equal to 2.0, or greater than or equal to 3.0, or greater than or equal to 4.0, or greater than or equal to 5.0, or greater than or equal to 6.0, or greater than or equal to 8.0, or greater than or equal to 10.0, or greater than or equal to 15.0, or greater than or equal to 20.0, or in the range from 0.1 to 30.0, or in the range from 0.5 to 30.0, or in the range from 1.0 to 30.0, or in the range from 1.5 to 30.0, or in the range from 2.0 to 30.0, or in the range from 3.0 to 30.0, or in the range from 4.0 to 30.0, or in the range from 5.0 to 30.0, or in the range from 0.1 to 20.0, or in the range from 0.5 to 20.0, or in the range from 1.0 to 20.0, or in the range from 1.5 to 20.0, or in the range from 2.0 to 20.0, or in the range from 3.0 to 20.0, or in the range from 4.0 to 20.0, or in the range from 5.0 to 20.0, or in the range from 0.1 to 10.0, or in the range from 0.5 to 10.0, or in the range from 1.0 to 10.0, or in the range from 1.5 to 10.0, or in the range from 2.0 to 10.0, or in the range from 3.0 to 10.0, or in the range from 4.0 to 10.0, or in the range from 5.0 to 10.0.

In embodiments, the ratio Al₂O₃/(Y₂O₃+La₂O₃+Gd₂O₃+Er₂O₃+Yb₂O₃+Lu₂O₃) is greater than or equal to 0.0, or greater than or equal to 0.1, or greater than or equal to 0.5, or greater than or equal to 1.0, or greater than or equal to 1.5, or greater than or equal to 2.0, or greater than or equal to 3.0, or greater than or equal to 4.0, or greater than or equal to 5.0, or greater than or equal to 6.0, or greater than or equal to 8.0, or greater than or equal to 10.0, or greater than or equal to 15.0, or greater than or equal to 20.0, or in the range from 0.0 to 30.0, or in the range from 0.1 to 30.0, or in the range from 0.5 to 30.0, or in the range from 1.0 to 30.0, or in the range from 1.5 to 30.0, or in the range from 2.0 to 30.0, or in the range from 3.0 to 30.0, or in the range from 4.0 to 30.0, or in the range from 5.0 to 30.0, or in the range from 0.0 to 20.0, or in the range from 0.1 to 20.0, or in the range from 0.5 to 20.0, or in the range from 1.0 to 20.0, or in the range from 1.5 to 20.0, or in the range from 2.0 to 20.0, or in the range from 3.0 to 20.0, or in the range from 4.0 to 20.0, or in the range from 5.0 to 20.0, or in the range from 0.0 to 15.0, or in the range from 0.1 to 15.0, or in the range from 0.5 to 15.0, or in the range from 1.0 to 15.0, or in the range from 1.5 to 15.0, or in the range from 2.0 to 15.0, or in the range from 3.0 to 15.0, or in the range from 4.0 to 15.0, or in the range from 5.0 to 15.0, or in the range from 0.0 to 10.0, or in the range from 0.1 to 10.0, or in the range from 0.5 to 10.0, or in the range from 1.0 to 10.0, or in the range from 1.5 to 10.0, or in the range from 2.0 to 10.0, or in the range from 3.0 to 10.0, or in the range from 4.0 to 10.0, or in the range from 5.0 to 10.0.

In embodiments, the ratio Al₂O₃/(Y₂O₃+La₂O₃+Gd₂O₃+Er₂O₃+Yb₂O₃+Lu₂O₃+Li₂O+Na₂O+K₂O) is greater than or equal to 0.0, or greater than or equal to 0.1, or greater than or equal to 0.5, or greater than or equal to 1.0, or greater than or equal to 1.5, or greater than or equal to 2.0, or greater than or equal to 3.0, or greater than or equal to 4.0, or greater than or equal to 5.0, or greater than or equal to 6.0, or greater than or equal to 8.0, or greater than or equal to 10.0, or in the range from 0.0 to 11.0, or in the range from 0.1 to 11.0, or in the range from 0.5 to 11.0, or in the range from 1.0 to 11.0, or in the range from 1.1 to 11.0, or in the range from 1.5 to 11.0, or in the range from 2.0 to 11.0, or in the range from 3.0 to 11.0, or in the range from 4.0 to 11.0, or in the range from 5.0 to 11.0, or in the range from 0.0 to 8.0, or in the range from 0.1 to 8.0, or in the range from 0.5 to 20.0, or in the range from 1.0 to 8.0, or in the range from 1.5 to 8.0, or in the range from 2.0 to 20.0, or in the range from 3.0 to 8.0, or in the range from 4.0 to 8.0, or in the range from 0.0 to 5.0, or in the range from 5.0 to 20.0, or in the range from 0.1 to 5.0, or in the range from 0.5 to 5.0, or in the range from 1.0 to 10.0, or in the range from 1.5 to 5.0, or in the range from 2.0 to 5.0.

In embodiments, the ratio (Y₂O₃+La₂O₃+Gd₂O₃+Yb₂O₃+Lu₂O₃)/Er₂O₃ is greater than or equal to 0.0, or greater than or equal to 0.1, or greater than or equal to 0.5, or greater than or equal to 1.0, or greater than or equal to 2.5, or greater than or equal to 5.0, or greater than or equal to 7.5, or greater than or equal to 10.0, or greater than or equal to 15.0, or greater than or equal to 20.0, or greater than or equal to 25.0, or greater than or equal to 30.0, or in the range from 0.0 to 40.0, or in the range from 0.1 to 35.0, or in the range from 0.5 to 35.0, or in the range from 0.6 to 30.0, or in the range from 1.0 to 30.0, or in the range from 2.5 to 30.0, or in the range from 5.0 to 30.0, or in the range from 0.6 to 25.0, or in the range from 1.0 to 25.0, or in the range from 2.5 to 25.0, or in the range from 5.0 to 25.0, or in the range from 0.6 to 20.0, or in the range from 1.0 to 20.0, or in the range from 2.5 to 20.0, or in the range from 5.0 to 20.0.

Reducing agents are included with the glass components to lower the hydroxyl content of the glasses. Reducing agents include elemental C, elemental Si, Al metal, silicon nitride (Si₃N₄), and aluminum nitride (AlN). The concentration of reducing agent is greater than or equal to 0.10 mol. %, or greater than or equal to 0.3 mol. %, or greater than or equal to 0.5 mol. %, or greater than or equal to 0.7 mol. %, or greater than or equal to 1.0 mol. %, or greater than or equal to 1.3 mol. %, or greater than or equal to 1.5 mol. %, or greater than or equal to 1.7 mol. %, or greater than or equal to 2.0 mol. %, or in the range from 0.1 mol. % to 3.0 mol. %, or in the range from 0.3 mol. % to 2.5 mol. %, or in the range from 0.5 mol. % to 2.0 mol. %, or in the range from 0.7 mol. % to 1.7 mol. %, or in the range from 1.0 mol. % to 1.5 mol. %.

Glasses were prepared by batching the glass components and reducing agents, mixing, loading into a crucible, calcining, melting, pouring, and pulling glass canes from the cooling melt. Calcining occurred at temperatures between 500° C. and 1400° C. for 1 to 24 hours, and preferably between 700° C. and 1250° C. for 4 to 20 hours. Calcining drives off chemisorbed water and hydroxyl groups before they become incorporated into the melt. Melting occurred at a temperature above 1500° C., such as 1650° C. A portion of the melt was then cast onto a graphite plate while the remainder was used to make canes. A bait rod was used to pull glass rods (“canes”) with diameters between 0.1 m and 5.0 mm from the remaining melt as it cools. Fibers were formed by inserting the glass rods into the central cavity of a silica or doped silica cladding tube to form a preform. The preform was heated to 1750° C.-2150° C. Fibers with core diameters between 1 μm and 8 μm, and cladding diameters between 80 μm and 125 μm were drawn. Specific examples of glass compositions and fibers are described below.

### Examples

The following examples describe compositions, methods, and performance of representative glasses and fibers that exhibit Er³⁺ emission with high quantum yield.

### Glass Preparation

The glasses are prepared by batching the glass components and a reducing agent, mixing, and loading into fused quartz crucibles. The glass components are preferably oxides, but may also include halides (e.g., Al₂F₆, Al₂C₆, NaCl, NaF, REF₃) in combination with oxides. The batch is initially calcined for 16 hours at 800° C. Halides are useful for reducing the β_{OH} of the glass since they react with hydroxyl groups to form HF, HCl, HBr, or HI depending on the halogen. These species are gasses which are swept away by the flowing gas atmosphere. Following initial calcining, the batch was either heated to 1200° C. for additional calcining or ramped directly to 1650° C. for melting. Depending on batch size, the melting time ranged from 2-6 hours. Ex. 1-136 were melted in ambient air without a controlled atmosphere. Controlled atmospheres include inert gases as well as N₂. 0.1 to 1% O₂ was used in Yb₂O₃ containing glasses to keep Yb ions as Yb³⁺ and prevent it from reducing to Yb²⁺. Ex. 137-145 were melted in a furnace adapted to provide a flowing Ar atmosphere. After melting, a portion of the melt was poured from the crucible and glass canes were pulled from the remaining melt using a fused quartz bait rod. The canes were 0.5-2.0 mm in diameter and about 1 meter long.

### Fiber Preparation

Fibers were prepared from the glass canes using the molten core method. A 0.1 meter long section of a glass cane was cut and inserted as core elements into a silica cladding tube to form preforms. The silica cladding tubes were pure silica or F-doped silica with an outside diameter of 30 mm and an inside diameter of 2 mm. The preforms were heated to a draw temperature of 1870° C. (F-doped silica cladding tube) or 2040° C. (pure silica cladding tube) and fibers were drawn at approximately 1 m/s. At the draw temperature, the glass canes melted and conformed to the inner diameter of the surrounding cladding tube. A partial vacuum was applied to the inside of the cladding tube to adjust the core size of the drawn fiber to approximately 4 microns. The outer diameter of the cladding of the fiber was adjustable and was typically 125 μm.

### Fiber Amplifiers

The fibers (cut to various lengths) were fusion spliced to a wavelength division multiplexer (WDM) to form amplifiers. The WDM multiplexed 980 nm pump light and C-band optical signal lasers (1528 nm-1568 nm, −10 dBm per channel) into the fiber. The output end of the fiber was spliced to a connecting fiber (CS-980) to couple the optical signal into an optical spectrum analyzer to measure amplifier performance.

Representative glass compositions are shown in the following Tables 1-15. All compositions are listed in terms of mol. % of the components and reducing agents. A small amount of SnO₂ is included as a fining agent. The concentrations of NaF, NaCl, LaF₃, Si, Al, C, and AlN are listed as oxide equivalents: Na₂F₂, Na₂Cl₂, La₂F₆, Si, Al₂, C, and Al₂N₂— to match cation stoichiometry of non-oxides with the corresponding oxides. Compositions as presented in Tables 1-15 sum to 100 mol. %. Blank entries signify a component that was not intentionally added to the batch composition or a measurement not completed. When measured, the tables also list density (in units of g/cm³ at room temperature), refractive index at 633 nm (n₆₃₃), refractive index at 1549 nm (n₁₅₄₉), Er³⁺ ion concentration (in units of 10¹⁸/cm³, so that an entry of 1.0 corresponds to an Er³⁺ ion concentration of 1.0×10¹⁸ ions/cm³), β_{OH} (in units of mm¹), and quantum yield (q, in units of %).

TABLE 1
Examples 1-10

| | 1 | 2 | 3 | 4 | 5 | 6 | 7 | 8 | 9 | 10 |
|---|---|---|---|---|---|---|---|---|---|---|
| SiO₂ | 67.0 | 67.0 | 67.0 | 67.0 | 67.0 | 67.0 | 67.0 | 67.0 | 67.0 | 64.0 |
| Al₂O₃ | 5.0 | 5.0 | 5.0 | 5.0 | 5.0 | 5.0 | 5.0 | 5.0 | 5.0 | 14.4 |
| Al₂Cl₆ | | | | | | | | | | |
| Al₂F₆ | | | | | | | | | | |
| B₂O₃ | 10.0 | 10.0 | 10.0 | 10.0 | 10.0 | 10.0 | 10.0 | 10.0 | 10.0 | |
| Na₂O | 8.7 | 8.7 | 8.7 | 8.7 | 8.7 | 8.7 | 6.7 | 5.7 | 8.7 | 21.4 |
| Na₂F₂ | | | | | | | | 3.0 | | |
| Na₂Cl₂ | 0.3 | 0.3 | 0.3 | 0.3 | 0.3 | 0.3 | 0.3 | 0.3 | 0.3 | |
| MgO | 3.0 | 3.0 | 3.0 | 3.0 | 3.0 | 3.0 | 3.0 | 3.0 | 3.0 | |
| CaO | | | | | | | | | | |
| SrO | 6.0 | 6.0 | 6.0 | 6.0 | 6.0 | 6.0 | 4.0 | 6.0 | 6.0 | |
| Y₂O₃ | | | | | | | 4.0 | | | |
| La₂O₃ | | | | | | | | | | |
| La₂F₆ | | | | | | | | | | |
| Er₂O₃ | | | | 0.1 | 0.2 | 0.3 | 0.3 | 0.3 | 0.3 | 0.3 |
| Yb₂O₃ | | | | | | | | | | |
| SnO₂ | 0.07 | 0.07 | 0.07 | 0.07 | 0.07 | 0.07 | 0.07 | 0.07 | 0.07 | 0.07 |
| Si | | | | | | | | | | |
| Al₂ | | | | | | | | | | |
| Al₂N₂ | | | | | | | | | | |
| C | | | | | | | | | | |
| Density | 2.705 | 2.711 | 2.709 | 2.716 | 2.719 | 2.736 | 2.82 | 2.722 | 2.729 | 2.483 |
| n₆₃₃ | | | | | | | | | | 1.504 |
| n₁₅₄₉ | | | | | | | | | | |
| Er³⁺ | 4.5 | 8.9 | 17.9 | 35.7 | 71.2 | 142.2 | 136.1 | 140.2 | 141.8 | 110.9 |
| β_{OH} | 0.214 | 0.220 | 0.219 | 0.198 | 0.187 | 0.200 | 0.307 | 0.273 | 0.594 | 0.055 |
| η | | 13.7% | 16.4% | 14.6% | 14.1% | 8.2% | 4.8% | 8.4% | 6.8% | 50.9% |

TABLE 2
Examples 11-20

| | 11 | 12 | 13 | 14 | 15 | 16 | 17 | 18 | 19 | 20 |
|---|---|---|---|---|---|---|---|---|---|---|
| SiO₂ | 64.0 | 64.0 | 64.0 | 64.0 | 64.0 | 64.0 | 64.0 | 64.0 | 69.5 | 69.0 |
| Al₂O₃ | 14.4 | 14.4 | 18.0 | 18.0 | 18.0 | 21.6 | 21.6 | 21.6 | 17.5 | 17.0 |
| Al₂Cl₆ | | | | | | | | | | |
| Al₂F₆ | | | | | | | | | | |
| B₂O₃ | | | | | | | | | | |
| Na₂O | | | 17.8 | | | 14.2 | | | 4.0 | 8.0 |
| Na₂F₂ | | | | | | | | | | |
| Na₂Cl₂ | | | | | | | | | | |
| MgO | | | | | | | | | | |
| CaO | 21.35 | | | 17.75 | | | 14.15 | | | |
| SrO | | | | | | | | | | |
| Y₂O₃ | | | | | | | | | | |
| La₂O₃ | | 21.4 | | | 17.8 | | | 14.2 | 8.8 | 5.8 |
| La₂F₆ | | | | | | | | | | |
| Er₂O₃ | 0.3 | 0.3 | 0.3 | 0.3 | 0.3 | 0.3 | 0.3 | 0.3 | 0.3 | 0.3 |
| Yb₂O₃ | | | | | | | | | | |
| SnO₂ | 0.07 | 0.07 | 0.07 | 0.07 | 0.07 | 0.07 | 0.07 | 0.07 | 0.07 | 0.07 |
| Si | | | | | | | | | | |
| Al₂ | | | | | | | | | | |
| Al₂N₂ | | | | | | | | | | |
| C | | | | | | | | | | |
| Density | 2.615 | 4.074 | 2.461 | 2.597 | 3.816 | 2.47 | 2.587 | 3.551 | 3.136 | 2.917 |
| n₆₃₃ | 1.551 | 1.710 | 1.501 | 1.546 | 1.681 | 1.506 | 1.543 | 1.660 | 1.598 | 1.563 |
| n₁₅₄₉ | | | | | | | | | | |
| Er³⁺ | 118.9 | 99.1 | 107.6 | 115.2 | 99.3 | 105.8 | 112.1 | 99.3 | 103.0 | 105.1 |
| β_{OH} | 0.058 | 0.100 | 0.078 | 0.071 | 0.122 | 0.094 | 0.082 | 0.144 | 0.089 | 0.134 |
| η | 38.8% | 51.6% | 59.0% | 41.7% | 50.5% | 49.4% | 42.2% | 46.3% | 56.1% | 46.5% |

TABLE 3
Examples 21-30

| | 21 | 22 | 23 | 24 | 25 | 26 | 27 | 28 | 29 | 30 |
|---|---|---|---|---|---|---|---|---|---|---|
| SiO₂ | 68.5 | 69.0 | 69.0 | 69.0 | 69.0 | 69.0 | 69.0 | 70.5 | 70.5 | 70.5 |
| Al₂O₃ | 16.5 | 17.0 | 17.0 | 17.0 | 17.0 | 17.0 | 17.0 | 6.0 | 0.5 | 0.5 |
| Al₂Cl₆ | | | | | | | | | | |
| Al₂F₆ | | | | | | | | | | |
| B₂O₃ | | | | | | | | | | |
| Na₂O | 12.0 | 4.0 | 4.0 | 4.0 | 8.0 | 8.0 | 8.0 | 14.0 | 14.0 | 14.0 |
| Na₂F₂ | | 4.0 | | 2.0 | | | | | | |
| Na₂Cl₂ | | | 4.0 | 2.0 | | | | | | |
| MgO | | | | | | | | | | |
| CaO | | | | | | | | 14.75 | 14.75 | 14.75 |
| SrO | | | | | | | | | | |
| Y₂O₃ | | | | | | | | | | |
| La₂O₃ | 2.8 | 5.8 | 5.8 | 5.8 | 5.9 | 5.5 | 5.0 | | | |
| La₂F₆ | | | | | | | | | | |
| Er₂O₃ | 0.3 | 0.3 | 0.3 | 0.3 | 0.1 | 0.5 | 1.0 | 0.3 | 0.3 | 0.3 |
| Yb₂O₃ | | | | | | | | | | |
| SnO₂ | 0.07 | 0.07 | 0.07 | 0.07 | 0.07 | 0.07 | 0.07 | | | |
| Si | | | | | | | | | | |
| Al₂ | | | | | | | | | 0.1 | |
| Al₂N₂ | | | | | | | | | | 0.1 |
| C | | | | | | | | | | |
| Density | 2.661 | 2.89 | 2.853 | 2.884 | 2.883 | 2.942 | 2.939 | 2.558 | 2.544 | 2.55 |
| n₆₃₃ | 1.526 | 1.549 | 1.571 | 1.554 | 1.563 | 1.564 | 1.563 | | | |
| n₁₅₄₉ | | | | | | | | | | |
| Er³⁺ | 106.2 | 103.1 | 100.2 | 102.1 | 52.0 | 211.7 | 421.6 | 126.5 | 125.8 | 126.1 |
| β_{OH} | 0.144 | 0.040 | 0.024 | 0.052 | 0.128 | 0.132 | 0.136 | 0.017 | −0.003 | 0.003 |
| η | 45.2% | 64.6% | 67.6% | 61.4% | 56.4% | 31.9% | 13.7% | 60.7% | 16.7% | 34.9% |

TABLE 4
Examples 31-40

| | 31 | 32 | 33 | 34 | 35 | 36 | 37 | 38 | 39 | 40 |
|---|---|---|---|---|---|---|---|---|---|---|
| SiO₂ | 69.0 | 69.0 | 69.0 | 69.0 | 69.0 | 69.0 | 69.0 | 69.0 | 69.0 | 69.0 |
| Al₂O₃ | 16.9 | 16.9 | 16.9 | 16.9 | 16.9 | 17.0 | 16.9 | 16.5 | 16.0 | 16.5 |
| Al₂Cl₆ | | | | | | | | | | |
| Al₂F₆ | | | | | | | | | | |
| B₂O₃ | | | | | | | | | | |
| Na₂O | 8.0 | 4.0 | 4.0 | 4.0 | 4.0 | 8.0 | 8.0 | 8.0 | 8.0 | 4.0 |
| Na₂F₂ | | | | | | | | | | |
| Na₂Cl₂ | | 4.0 | 4.0 | 4.0 | 4.0 | | | | | 4.0 |
| MgO | | | | | | | | | | |
| CaO | | | | | | | | | | |
| SrO | | | | | | | | | | |
| Y₂O₃ | | | | | | | | | | |
| La₂O₃ | 5.8 | 5.8 | 5.8 | 5.8 | 5.8 | 5.8 | 5.8 | 5.8 | 5.8 | 5.8 |
| La₂F₆ | | | | | | | | | | |
| Er₂O₃ | 0.3 | 0.3 | 0.3 | 0.3 | 0.3 | 0.3 | 0.3 | 0.3 | 0.3 | 0.3 |
| Yb₂O₃ | | | | | | | | | | |
| SnO₂ | | | | | | | | | | |
| Si | | | | | | | | | | |
| Al₂ | 0.1 | 0.1 | 0.2 | | | | | | | |
| Al₂N₂ | | | | 0.1 | 0.1 | | 0.1 | 0.5 | 1 | 0.5 |
| C | | | | | | | | | | |
| Density | 2.904 | 2.879 | 2.885 | 2.882 | 2.873 | 2.898 | 2.904 | 2.895 | 2.926 | 2.877 |
| n₆₃₃ | | | | | | 1.563 | 1.560 | 1.562 | 1.562 | 1.580 |
| n₁₅₄₉ | | | | | | | | | | |
| Er³⁺ | 104.8 | 101.2 | 101.3 | 101.4 | 101.0 | 104.6 | 104.8 | 104.5 | 105.6 | 101.2 |
| β_{OH} | 0.171 | 0.080 | 0.046 | 0.043 | 0.040 | 0.080 | 0.046 | 0.002 | 0.001 | 0.000 |
| η | 54.4% | 70.3% | 71.0% | 73.9% | 72.6% | 62.4% | 66.3% | 38.8% | 30.2% | 43.7% |

TABLE 5
Examples 41-50

| | 41 | 42 | 43 | 44 | 45 | 46 | 47 | 48 | 49 | 50 |
|---|---|---|---|---|---|---|---|---|---|---|
| SiO₂ | 64.0 | 64.0 | 64.0 | 64.0 | 64.0 | 64.0 | 64.0 | 64.0 | 64.0 | 64.0 |
| Al₂O₃ | 15.9 | 15.5 | 15.5 | 21.1 | 21.4 | 21.1 | 20.6 | 20.6 | 20.1 | 20.1 |
| Al₂Cl₆ | | | | | | | | | | |
| Al₂F₆ | | | | | | | | | | |
| B₂O₃ | | | | | | | | | | |
| Na₂O | | | | | | | | | 2.0 | |
| Na₂F₂ | | | | | | | | | | |
| Na₂Cl₂ | | | | | | | | | | 2.0 |
| MgO | | | | | | | | | | |
| CaO | 20.0 | 20.0 | 20.0 | | | | | | | |
| SrO | | | | | | | | | | |
| Y₂O₃ | | | | | | | | | | |
| La₂O₃ | | | | 14.2 | 14.2 | 14.2 | 14.2 | 14.2 | 13.2 | 13.2 |
| La₂F₆ | | | | | | | | | | |
| Er₂O₃ | 0.3 | 0.3 | 0.3 | 0.3 | 0.3 | 0.3 | 0.3 | 0.3 | 0.3 | 0.3 |
| Yb₂O₃ | | | | | | | | | | |
| SnO₂ | | | | | | | | | | |
| Si | | | | | | | | | | |
| Al₂ | | | | | | | | | | |
| Al₂N₂ | 0.1 | 0.5 | 0.5 | 0.5 | 0.25 | 0.5 | 1.0 | 1.0 | 0.5 | 0.5 |
| C | | | | | | | | | | |
| Density | 2.604 | 2.606 | 2.574 | 3.448 | 3.307 | 3.313 | 3.39 | 3.355 | 3.222 | 3.326 |
| n₆₃₃ | 1.549 | 1.549 | 1.546 | 1.640 | | | | | | |
| n₁₅₄₉ | | | | | | | | | | |
| Er³⁺ | 117.1 | 117.1 | 112.0 | 96.5 | 92.6 | 92.8 | 94.9 | 93.9 | 92.8 | 94.8 |
| β_{OH} | 0.065 | 0.042 | 0.000 | 0.009 | 0.092 | 0.030 | 0.004 | 0.030 | 0.061 | 0.017 |
| η | 35.8% | 45.5% | 55.9% | 73.1% | 68.4% | 66.7% | 76.3% | 51.7% | 51.9% | 69.1% |

TABLE 6
Examples 51-60

| | 51 | 52 | 53 | 54 | 55 | 56 | 57 | 58 | 59 | 60 |
|---|---|---|---|---|---|---|---|---|---|---|
| SiO₂ | 64.0 | 64.0 | 64.0 | 64.0 | 64.0 | 64.0 | 64.0 | 64.0 | 64.0 | 64.0 |
| Al₂O₃ | 20.1 | 20.1 | 21.1 | 21.1 | 20.6 | 19.6 | 17.6 | 19.3 | 20.6 | 20.6 |
| Al₂Cl₆ | | | | | | | | | | |
| Al₂F₆ | | | | | | | | 1.3 | | |
| B₂O₃ | | | | | | | | | | |
| Na₂O | | | | | | | | | 4.0 | |
| Na₂F₂ | 2.0 | 2.0 | | | | | | | | |
| Na₂Cl₂ | | | | | | | | | | 4.0 |
| MgO | | | | | | | | | | |
| CaO | | | | | | | | | | |
| SrO | | | | | | | | | | |
| Y₂O₃ | | | | | | | | | | |
| La₂O₃ | 13.2 | 13.2 | 14.3 | 13.9 | 14.2 | 14.2 | 14.2 | 14.2 | 10.2 | 10.2 |
| La₂F₆ | | | | | | | | | | |
| Er₂O₃ | 0.3 | 0.3 | 0.1 | 0.5 | 0.3 | 0.3 | 0.3 | 0.3 | 0.3 | 0.3 |
| Yb₂O₃ | | | | | | | | | | |
| SnO₂ | | | | | | | | | | |
| Si | | | | | | | | | | |
| Al₂ | | | | | | | | | | |
| Al₂N₂ | 0.5 | 0.5 | 0.5 | 0.5 | 1.0 | 2.0 | 4.0 | 1.0 | 1.0 | 1.0 |
| C | | | | | | | | | | |
| Density | 3.254 | 3.254 | 3.339 | 3.386 | 3.342 | 3.377 | 3.411 | 3.333 | 3.123 | 3.083 |
| n₆₃₃ | | | | | | | | | | |
| n₁₅₄₉ | | | | | | | | | | |
| Er³⁺ | 93.4 | 93.4 | 37.4 | 189.4 | 93.6 | 94.6 | 95.5 | 92.6 | 97.0 | 93.6 |
| β_{OH} | 0.008 | | 0.026 | 0.033 | 0.003 | 0.001 | 0.000 | 0.003 | 0.018 | 0.001 |
| η | 70.0% | 64.0% | 59.8% | 54.4% | 81.1% | 72.9% | 58.2% | 71.9% | 79.5% | 77.1% |

TABLE 7
Examples 61-70

| | 61 | 62 | 63 | 64 | 65 | 66 | 67 | 68 | 69 | 70 |
|---|---|---|---|---|---|---|---|---|---|---|
| SiO₂ | 64.0 | 64.0 | 64.0 | 64.0 | 64.0 | 64.0 | 64.0 | 64.0 | 64.0 | 64.0 |
| Al₂O₃ | 20.6 | 20.6 | 20.6 | 20.6 | 20.6 | 20.6 | 20.6 | 20.6 | 20.6 | 20.4 |
| Al₂Cl₆ | | | | | | | | | | |
| Al₂F₆ | | | | | | | | | | |
| B₂O₃ | | | | | | | | | | |
| Na₂O | | | | | | | | | | |
| Na₂F₂ | | | | | | | | | | |
| Na₂Cl₂ | | | | | | | | | | |
| MgO | | | | | | | | | | |
| CaO | | | | | | | | | | |
| SrO | | | | | | | | | | |
| Y₂O₃ | 7.1 | 14.2 | 14.2 | | | | | | | |
| La₂O₃ | 7.1 | | | 12.8 | 12.8 | 14.3 | 14.2 | 13.9 | 13.4 | 13.4 |
| La₂F₆ | | | | 1.3 | 1.3 | | | | | |
| Er₂O₃ | 0.3 | 0.3 | 0.3 | 0.3 | 0.3 | 0.1 | 0.3 | 0.5 | 1.0 | 1.0 |
| Yb₂O₃ | | | | | | | | | | |
| SnO₂ | | | | | | | | | | |
| Si | | | | | | | | | | |
| Al₂ | | | | | | | | | | |
| Al₂N₂ | 1.0 | 1.0 | 1.0 | 1.0 | 1.0 | 1.0 | 1.0 | 1.0 | 1.0 | 1.2 |
| C | | | | | | | | | | |
| Density | 3.256 | 3.145 | 3.145 | | | 3.53 | 3.487 | 3.378 | 3.374 | 3.094 |
| n₆₃₃ | | | | | | 1.632 | 1.633 | 1.633 | 1.632 | 1.634 |
| n₁₅₄₉ | | | | | | 1.622 | 1.615 | 1.616 | 1.615 | 1.614 |
| Er³⁺ | 97.6 | 101.4 | 101.4 | 0.0 | 0.0 | 49.5 | 97.6 | 188.9 | 376.4 | 345.2 |
| β_{OH} | 0.008 | 0.010 | | 0.133 | | 0.001 | 0.002 | 0.001 | 0.001 | 0.002 |
| η | 81.4% | 78.6% | 78.1% | 54.7% | 60.2% | 79.8% | 83.2% | 81.2% | 80.4% | 80.9% |

TABLE 8
Examples 71-80

| | 71 | 72 | 73 | 74 | 75 | 76 | 77 | 78 | 79 | 80 |
|---|---|---|---|---|---|---|---|---|---|---|
| SiO₂ | 64.0 | 64.0 | 64.0 | 64.0 | 64.0 | 67.0 | 67.0 | 67.0 | 67.0 | 67.0 |
| Al₂O₃ | 23.0 | 23.0 | 26.0 | 23.0 | 18.0 | 21.0 | 20.6 | 21.0 | 21.0 | 21.0 |
| Al₂Cl₆ | | | | | | | | | | |
| Al₂F₆ | | | | | | | | | | |
| B₂O₃ | | | | | | | | | | |
| Na₂O | | | | | | | | | | |
| Na₂F₂ | | | | | | | | | | |
| Na₂Cl₂ | | | | | 5.0 | | | | | |
| MgO | | | | | | | | | | |
| CaO | | | | | | | | | | |
| SrO | | | | | | | | | | |
| Y₂O₃ | | | | 5.5 | 5.5 | | | | | |
| La₂O₃ | 11.0 | 11.0 | 8.0 | 5.5 | 5.5 | 10.0 | 10.0 | 9.0 | 7.0 | 10.0 |
| La₂F₆ | | | | | | | | | | |
| Er₂O₃ | 1.0 | 1.0 | 1.0 | 1.0 | 1.0 | 1.0 | 1.0 | 2.0 | 4.0 | 0.3 |
| Yb₂O₃ | | | | | | | | | | 0.75 |
| SnO₂ | | | | | | | | | | |
| Si | | | | | | | | | | |
| Al₂ | | | | | | | | | | |
| Al₂N₂ | 1.0 | 1.0 | 1.0 | 1.0 | 1.0 | 1.0 | 1.4 | 1.0 | 1.0 | 1.0 |
| C | | | | | | | | | | |
| Density | 4.201 | 3.274 | 3.163 | 3.184 | 3.671 | 3.287 | 3.293 | 3.278 | 3.34 | 3.288 |
| n₆₃₃ | 1.610 | 1.613 | 1.603 | 1.621 | 1.625 | 1.618 | 1.620 | 1.619 | 1.613 | 1.619 |
| n₁₅₄₉ | 1.617 | 1.593 | 1.596 | 1.604 | 1.608 | 1.601 | 1.603 | 1.602 | 1.597 | 1.602 |
| Er³⁺ | | 384.4 | 397.3 | 395.0 | 452.0 | 399.5 | 400.2 | 792.3 | 1596.4 | 99.8 |
| β_{OH} | 0.001 | 0.043 | 0.001 | 0.002 | 0.001 | 0.005 | 0.001 | 0.005 | 0.002 | 0.012 |
| η | | 51.4% | 78.6% | 77.1% | 73.4% | 70.1% | 79.0% | 46.8% | 24.0% | 67.2% |

TABLE 9
Examples 81-90

| | 81 | 82 | 83 | 84 | 85 | 86 | 87 | 88 | 89 | 90 |
|---|---|---|---|---|---|---|---|---|---|---|
| SiO₂ | 67.0 | 67.0 | 67.0 | 67.0 | 67.0 | 69.0 | 69.0 | 69.0 | 70.0 | 79.0 |
| Al₂O₃ | 21.0 | 21.0 | 21.0 | 21.0 | 21.0 | 16.5 | 16.0 | 16.5 | 19.0 | 13.0 |
| Al₂Cl₆ | | | | | | | | | | |
| Al₂F₆ | | | | | | | | | | |
| B₂O₃ | | | | | | | | | | |
| Na₂O | | | | | | 8.0 | 8.0 | 4.0 | | |
| Na₂F₂ | | | | | | | | | | |
| Na₂Cl₂ | | | | | | | | 4.0 | | |
| MgO | | | | | | | | | | |
| CaO | | | | | | | | | | |
| SrO | | | | | | | | | | |
| Y₂O₃ | | | | | | | | | 9.0 | 6.0 |
| La₂O₃ | 10.0 | 10.0 | 8.5 | 10.0 | 10.0 | 5.5 | 5.5 | 5.5 | | |
| La₂F₆ | | | | | | | | | | |
| Er₂O₃ | 0.1 | 0.1 | 0.3 | 1.0 | 1.0 | 0.5 | 0.5 | 0.5 | 1.0 | 1.0 |
| Yb₂O₃ | 0.91 | 0.91 | | | | | | | | |
| SnO₂ | | | | | | | | | | |
| Si | | | | | | | 1.5 | | | |
| Al₂ | | | | 1.0 | 1.0 | | | | | |
| Al₂N₂ | 1.0 | 1.0 | 1.0 | | | 0.5 | 1.0 | 1.0 | 1.0 | 1.0 |
| C | | | | | | | | | | |
| Density | 3.272 | 3.272 | 3.315 | 3.236 | 3.236 | 2.89 | 2.903 | 2.861 | 3.004 | 2.786 |
| n₆₃₃ | 1.619 | 0.000 | 1.618 | | | | | | | |
| n₁₅₄₉ | 1.602 | | 1.601 | | | | | | | |
| Er³⁺ | 36.1 | 36.1 | 99.6 | 393.3 | 393.3 | 208.2 | 209.2 | 199.7 | 417.8 | 424.1 |
| β_{OH} | 0.013 | | 0.012 | | | 0.017 | 0.002 | 0.002 | 0.001 | 0.002 |
| η | 49.6% | 64.3% | 34.7% | 53.9% | 44.9% | 67.0% | 72.9% | 72.8% | 68.5% | 62.6% |

TABLE 10
Examples 91-100

| | 91 | 92 | 93 | 94 | 95 | 96 | 97 | 98 | 99 | 100 |
|---|---|---|---|---|---|---|---|---|---|---|
| SiO₂ | 85.0 | 67.0 | 67.0 | 67.0 | 69.0 | 69.0 | 67.5 | 69.0 | 78.0 | 84.0 |
| Al₂O₃ | 9.0 | 21.0 | 21.8 | 21.5 | 16.3 | 16.0 | 17.0 | 0.0 | 0.0 | 0.0 |
| Al₂Cl₆ | | | | | | | | | | |
| Al₂F₆ | | | | | | | | | | |
| B₂O₃ | | | | | | | | | | |
| Na₂O | | | | | 4.0 | 4.0 | 4.0 | 20.0 | 14.0 | 10.0 |
| Na₂F₂ | | | | | | | | | | |
| Na₂Cl₂ | | | | | 4.0 | 4.0 | 4.0 | | | |
| MgO | | | | | | | | | | |
| CaO | | | | | | | | | | |
| SrO | | | | | | | | | | |
| Y₂O₃ | 4.0 | | | | | | | 9.5 | 6.5 | 4.5 |
| La₂O₃ | | 10.0 | 10.0 | 10.0 | 5.5 | 5.5 | 5.5 | | | |
| La₂F₆ | | | | | | | | | | |
| Er₂O₃ | 1.0 | 1.0 | 1.0 | 1.0 | 0.5 | 0.5 | 0.5 | 0.5 | 0.5 | 0.5 |
| Yb₂O₃ | | | | | | | | | | |
| SnO₂ | | | | | | | | | | |
| Si | 1.5 | | 1.125 | | 1.0 | 1.25 | 1.5 | 0.6 | 0.8 | 1.0 |
| Al₂ | | | 0.25 | 0.5 | | | | | | |
| Al₂N₂ | 1.0 | 1.0 | | | 0.75 | 1.0 | | 1.0 | 1.0 | 1.0 |
| C | | | | | | | | | | |
| Density | 2.708 | 3.293 | 3.295 | 3.275 | 2.88 | 2.869 | 2.859 | | 2.75 | 2.619 |
| n₆₃₃ | | | | | 1.564 | 1.557 | 1.563 | | 1.632 | 1.558 |
| n₁₅₄₉ | | | | | 1.544 | 1.541 | 1.548 | | 1.530 | 1.543 |
| Er³⁺ | 440.0 | 400.2 | 400.5 | 398.0 | 202.2 | 201.4 | 201.9 | | 226.4 | 226.1 |
| β_{OH} | | 0.014 | 0.333 | 0.145 | 0.009 | 0.002 | 0.000 | | 0.002 | 0.001 |
| η | 49.8% | 58.2% | 14.8% | 26.9% | 77.3% | 76.0% | 75.6% | | 69.2% | 69.6% |

TABLE 11
Examples 101-110

| | 101 | 102 | 103 | 104 | 105 | 106 | 107 | 108 | 109 | 110 |
|---|---|---|---|---|---|---|---|---|---|---|
| SiO₂ | 77.5 | 67.0 | 65.9 | 69.0 | 68.0 | 67.8 | 67.5 | 66.4 | 66.2 | 66.0 |
| Al₂O₃ | 0.0 | 21.3 | 22.0 | 16.0 | 17.0 | 17.0 | 17.0 | 22.0 | 22.0 | 22.0 |
| Al₂Cl₆ | | | | | | | | | | |
| Al₂F₆ | | | | | | | | | | |
| B₂O₃ | | | | | | | | | | |
| Na₂O | 14.0 | | | 4.0 | 4.0 | 4.0 | 4.0 | | | |
| Na₂F₂ | | | | | | | | | | |
| Na₂Cl₂ | | | | 4.0 | 4.0 | 4.0 | 4.0 | | | |
| MgO | | | | | | | | | | |
| CaO | | | | | | | | | | |
| SrO | | | | | | | | | | |
| Y₂O₃ | 6.5 | | | | | | | | | |
| La₂O₃ | | 10.5 | 10.5 | 5.0 | 5.0 | 5.0 | 5.0 | 10.0 | 10.0 | 10.0 |
| La₂F₆ | | | | | | | | | | |
| Er₂O₃ | 0.5 | 0.5 | 0.5 | 1.0 | 1.0 | 1.0 | 1.0 | 1.0 | 1.0 | 1.0 |
| Yb₂O₃ | | | | | | | | | | |
| SnO₂ | | | | | | | | | | |
| Si | 1.5 | | 1.1 | | 1.0 | 1.3 | 1.5 | 0.6 | 0.8 | 1.0 |
| Al₂ | | 0.75 | | | | | | | | |
| Al₂N₂ | | | | 1.0 | | | | | | |
| C | | | | | | | | | | |
| Density | 2.745 | 3.226 | 3.184 | 2.877 | 2.939 | 2.896 | 2.914 | 3.26 | 3.263 | 3.251 |
| n₆₃₃ | 1.540 | 1.614 | 1.605 | 1.557 | 1.574 | 1.563 | 1.572 | 1.618 | 1.614 | |
| n₁₅₄₉ | 1.525 | 1.597 | 1.589 | 1.542 | 1.558 | 1.548 | 1.563 | 1.601 | 1.597 | |
| Er³⁺ | 228.8 | 196.6 | 194.8 | 402.7 | 412.9 | 407.2 | 410.2 | 397.0 | 397.6 | 396.4 |
| β_{OH} | 0.004 | 0.000 | 0.000 | 0.004 | 0.016 | 0.018 | 0.006 | 0.000 | 0.000 | |
| η | 72.4% | 55.0% | 71.2% | 69.4% | 49.8% | 65.7% | 60.5% | 65.9% | 66.5% | |

TABLE 12
Examples 111-120

| | 111 | 112 | 113 | 114 | 115 | 116 | 117 | 118 | 119 | 120 |
|---|---|---|---|---|---|---|---|---|---|---|
| SiO₂ | 66.0 | 66.0 | 69.0 | 67.7 | 66.7 | 66.6 | 66.5 | 67.0 | 67.0 | 67.0 |
| Al₂O₃ | 22.0 | 22.0 | 16.1 | 17.0 | 22.0 | 22.0 | 22.0 | 22.0 | 22.0 | 22.0 |
| Al₂Cl₆ | | | | | | | | | | |
| Al₂F₆ | | | | | | | | | | |
| B₂O₃ | | | | | | | | | | |
| Na₂O | | | 4.0 | 4.0 | | | | | | |
| Na₂F₂ | | | | | | | | | | |
| Na₂Cl₂ | | | 4.0 | 4.0 | | | | | | |
| MgO | | | | | | | | | | |
| CaO | | | | | | | | | | |
| SrO | | | | | | | | | | |
| Y₂O₃ | 5.0 | 10.0 | | | | | | | | |
| La₂O₃ | 5.0 | | 5.0 | 5.0 | 10.0 | 10.0 | 10.0 | 10.0 | 10.0 | 10.0 |
| La₂F₆ | | | | | | | | | | |
| Er₂O₃ | 1.0 | 1.0 | 1.0 | 1.0 | 1.0 | 1.0 | 1.0 | 1.0 | 1.0 | 1.0 |
| Yb₂O₃ | | | | | | | | | | |
| SnO₂ | | | | | | | | | | |
| Si | 1.0 | 1.0 | | 1.3 | 0.3 | 0.4 | 0.5 | | | |
| Al₂ | | | | | | | | | | |
| Al₂N₂ | | | | | | | | | | |
| C | | | | | | | | 1.0 | 2.0 | 3.0 |
| Density | 3.164 | | 2.856 | 2.92 | 3.253 | 3.213 | 3.224 | 3.25 | 3.24 | 3.252 |
| n₆₃₃ | | | | | | | | | | |
| n₁₅₄₉ | | | | | | | | | | |
| Er³⁺ | 406.4 | | 399.8 | 410.7 | 395.7 | 391.0 | 392.5 | 394.5 | 392.8 | 393.8 |
| β_{OH} | | | 0.002 | 0.004 | 0.003 | 0.001 | 0.001 | 0.164 | 0.123 | 0.103 |
| η | | | 70.7% | 71.0% | 72.2% | 77.3% | 79.3% | 26.5% | 32.3% | 34.8% |

TABLE 13
Examples 121-130

| | 121 | 122 | 123 | 124 | 125 | 126 | 127 | 128 | 129 | 130 |
|---|---|---|---|---|---|---|---|---|---|---|
| SiO₂ | 66.6 | 66.6 | 66.6 | 66.6 | 66.6 | 66.6 | 66.6 | 66.6 | 67.0 | 66.5 |
| Al₂O₃ | 22.0 | 22.0 | 22.0 | 22.0 | 22.0 | 22.0 | 24.8 | 26.4 | 22.0 | 26.4 |
| Al₂Cl₆ | | | | | | | | | | |
| Al₂F₆ | | | | | | | | | | |
| B₂O₃ | | | | | | | | | | |
| Na₂O | | | | | | | | | | |
| Na₂F₂ | | | | | | | | | | |
| Na₂Cl₂ | | | | | | | | | | |
| MgO | | | | | | | | | | |
| CaO | | | | | | | | | | |
| SrO | | | | | | | | | | |
| Y₂O₃ | | | | | | | | | | |
| La₂O₃ | 10.0 | 9.8 | 9.5 | 9.0 | 8.0 | 7.0 | 7.3 | 5.6 | 10.0 | 5.6 |
| La₂F₆ | | | | | | | | | | |
| Er₂O₃ | 1.0 | 1.3 | 1.5 | 2.0 | 3.0 | 4.0 | 1.0 | 1.0 | 1.0 | 1.0 |
| Yb₂O₃ | | | | | | | | | | |
| SnO₂ | | | | | | | | | | |
| Si | 0.4 | 0.4 | 0.4 | 0.4 | 0.4 | 0.4 | 0.4 | 0.4 | | 0.5 |
| Al₂ | | | | | | | | | | |
| Al₂N₂ | | | | | | | | | | |
| C | | | | | | | | | | |
| Density | 3.25 | 3.26 | 3.234 | 3.271 | 3.309 | 3.316 | 3.086 | 2.99 | 3.242 | 2.989 |
| n₆₃₃ | 1.614 | 1.612 | 1.622 | 1.610 | 1.613 | 1.609 | 1.593 | 1.580 | 1.611 | 1.580 |
| n₁₅₄₉ | 1.598 | 1.594 | 1.605 | 1.592 | 1.600 | 1.591 | 1.577 | 1.564 | 1.594 | 1.564 |
| Er³⁺ | 395.5 | 495.2 | 588.7 | 791.6 | 1194 | 1587 | 400.5 | 404.1 | 393.1 | 404.1 |
| β_{OH} | 0.001 | 0.001 | 0.001 | 0.002 | 0.001 | 0.001 | 0.004 | 0.001 | 0.000 | 0.003 |
| η | 76.5% | 75.3% | 72.7% | 60.3% | 69.1% | 47.6% | 78.4% | 81.9% | 71.8% | 75.3% |

TABLE 14
Examples 131-140

| | 131 | 132 | 133 | 134 | 135 | 136 | 137 | 138 | 139 | 140 |
|---|---|---|---|---|---|---|---|---|---|---|
| SiO₂ | 66.3 | 66.0 | 66.5 | 66.5 | 66.5 | 66.5 | 66.5 | 66.5 | 66.5 | 67.0 |
| Al₂O₃ | 26.4 | 26.4 | 26.4 | 26.4 | 26.4 | 27.5 | 28.0 | 24.0 | 26.4 | 25.1 |
| Al₂Cl₆ | | | | | | | | | | 1.3 |
| Al₂F₆ | | | | | | | | | | |
| B₂O₃ | | | | | | | | | | |
| Na₂O | | | | | | | | | | |
| Na₂F₂ | | | | | | | | | | |
| Na₂Cl₂ | | | | | | | | 4.0 | | |
| MgO | | | | | | | | | | |
| CaO | | | | | | | | | | |
| SrO | | | | | | | | | | |
| Y₂O₃ | | | | | | | | | | |
| La₂O₃ | 5.6 | 5.6 | 5.1 | 4.6 | 4.1 | 4.5 | 4.0 | 4.0 | 4.6 | 4.6 |
| La₂F₆ | | | | | | | | | | |
| Er₂O₃ | 1.0 | 1.0 | 1.5 | 2.0 | 2.5 | 1.0 | 1.0 | 1.0 | 2.0 | 2.0 |
| Yb₂O₃ | | | | | | | | | | |
| SnO₂ | | | | | | | | | | |
| Si | 0.8 | 1.0 | 0.5 | 0.5 | 0.5 | 0.5 | 0.5 | 0.5 | 0.5 | |
| Al₂ | | | | | | | | | | |
| Al₂N₂ | | | | | | | | | | |
| C | | | | | | | | | | |
| Density | 2.987 | 2.983 | 3 | 3.021 | 3.028 | | | 2.813 | 3.004 | 2.844 |
| n₆₃₃ | 1.581 | 1.582 | 1.580 | 1.579 | 1.578 | | | 1.556 | | |
| n₁₅₄₉ | 1.565 | 1.565 | 1.564 | 1.563 | 1.562 | | | 1.541 | | |
| Er³⁺ | 404.2 | 404.0 | 606.4 | 811.7 | 1014 | | | 393.6 | 807.1 | 774.6 |
| β_{OH} | 0.002 | 0.001 | 0.002 | 0.001 | 0.003 | | | 0.003 | | 0.004 |
| η | 79.6% | 72.2% | 72.0% | 70.8% | 54.9% | 82.6% | 75.2% | 81.4% | 42.0% | 75.3% |

TABLE 15
Examples 141-145

| | 141 | 142 | 143 | 144 | 145 |
|---|---|---|---|---|---|
| SiO₂ | 67.0 | 67.0 | 66.5 | 70.0 | 70.0 |
| Al₂O₃ | 24.0 | 24.0 | 24.0 | 22.0 | 22.0 |
| Al₂Cl₆ | | | | 0.5 | 0.5 |
| Al₂F₆ | | | | | |
| B₂O₃ | | | | | |
| Na₂O | | | | | |
| Na₂F₂ | | | | | |
| Na₂Cl₂ | 4.0 | 4.0 | 4.0 | | |
| MgO | | | | | |
| CaO | | | | | |
| SrO | | | | | |
| Y₂O₃ | | | | | |
| La₂O₃ | 3.0 | 3.0 | 3.0 | 5.5 | 5.5 |
| La₂F₆ | | | | | |
| Er₂O₃ | 2.0 | 2.0 | 2.0 | 2.0 | 1.0 |
| Yb₂O₃ | | | | | 1.0 |
| SnO₂ | | | | | |
| Si | | | 0.5 | | |
| Al₂ | | | | | |
| Al₂N₂ | | | | | |
| C | | | | | |
| Density | 2.868 | 2.872 | | 3.042 | 3.051 |
| n₆₃₃ | | | | | |
| n₁₅₄₉ | | | | | |
| Er³⁺ | 812.8 | 820.2 | | 811.8 | 397.2 |
| β_{OH} | 0.002 | 0.007 | | 0.002 | 0.002 |
| η | 71.1% | 52.1% | | 76.3% | 90.6% |

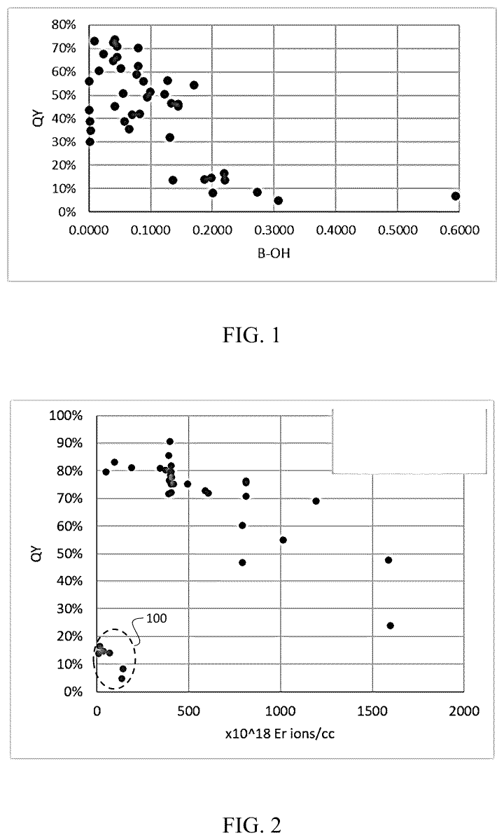

FIG. 1 shows quantum yield QY (%) as a function of β_{OH} (mm⁻¹) for several examples selected from Tables 1-15. The examples have Er³⁺ ion concentrations above 1.0×10¹⁹/cm³, including Er³⁺ ion concentrations above 5.0×10¹⁹/cm³ and Er³⁺ ion concentrations above 1.0×10²⁰/cm³, The data illustrate that quantum yield decreases as β_{OH} increases. Accordingly, it is desirable to reduce β_{OH}. As noted above, calcining the batch before melting to remove chemisorbed hydroxyl groups and/or inclusion of a reducing agent in the melt to convert hydroxyl groups to hydrogen gas act to promote reductions in β_{OH}. In embodiments herein, OH is less than 0.100/mm, or less than 0.080/mm, or less than 0.060/mm, or less than 0.040/mm, or less than 0.020/mm, or less than 0.010/mm, or less than 0.005/mm, or in the range from 0.001/mm to 0.100/mm, or in the range from 0.002/mm to 0.080/mm, or in the range from 0.005/mm to 0.060/mm, or in the range from 0.010/mm to 0.050/mm.

FIG. 2 shows quantum yield QY (%) as a function of Er³⁺ ion concentration (×10¹⁸/cm³) for selected examples from Tables 1-15. Encircled points 100 correspond to Ex. 2-7 from Table 1. Ex. 2-7 are comparative examples of glasses with high Er³⁺ ion concentration that were prepared without the aid of a reducing agent. The batches for Ex. 2-7 were calcined, but lacked a reducing agent. Absence of a reducing agent led to high β_{OH} for Ex. 2-7 and a corresponding reduction in quantum yield. The remaining data points shown in FIG. 2 correspond to examples that included a reducing agent in the batch composition (Ex. 66-Ex. 70, Ex. 77-79, Ex. 121-135, Ex. 137-139, Ex. 143) and/or preparation under a controlled Ar atmosphere (Ex. 137-145). The reducing agents in the batches included AlN (Ex. 66-Ex. 70, Ex. 77-79) and elemental Si (Ex. 121-Ex. 128, Ex. 130-135, Ex. 137-139, Ex. 143). The results of FIG. 2 indicate that glasses in accordance with embodiments of the present disclosure exhibit a quantum yield greater than 80% even when the Er³⁺ ion concentration is greater than 100×10¹⁸/cm³ (1.0×10²⁰/cm³). For the comparative examples, the quantum yield was less than 20% at much lower concentrations of Er³ ions. FIG. 2 illustrates that in some embodiments, the quantum yield is above 20% even when the concentration of Er³⁺ ions exceeds 1500×10¹⁸/cm³ (1.5×10²¹/cm³). The notable improvement in quantum yield for the present glasses is due to a reduction in hydroxyl quenching and concentration quenching of the luminescence of Er³⁺ ions through selection of glass composition, inclusion of a reducing agent, and/or melting in an inert gas environment (with or without a reducing agent).

In embodiments, the quantum yield of the present Er₂O₃-containing glasses is greater than 20% or greater than 40%, or greater than 60% or greater than 70%, or greater than 80%, or greater than 90%, or in the range from 20% to 95%, or in the range from 40% to 90%, or in the range from 60% to 90%, or in the range from 70% to 90% when the Er³⁺ ion concentration is greater than 1.0×10¹⁹/cm³.

In embodiments, the quantum yield of the present Er₂O₃-containing glasses is greater than 20% or greater than 40%, or greater than 60% or greater than 70%, or greater than 80%, or greater than 90%, or in the range from 20% to 95%, or in the range from 40% to 90%, or in the range from 60% to 90%, or in the range from 70% to 90% when the Er³⁺ ion concentration is greater than 5.0×10¹⁹/cm³.

In embodiments, the quantum yield of the present Er₂O₃-containing glasses is greater than 20% or greater than 40%, or greater than 60% or greater than 70%, or greater than 80%, or greater than 90%, or in the range from 20% to 95%, or in the range from 40% to 90%, or in the range from 60% to 90%, or in the range from 70% to 90% when the Er³⁺ ion concentration is greater than 1.0×10²⁰/cm³.

In embodiments, the quantum yield of the present Er₂O₃-containing glasses is greater than 20% or greater than 40%, or greater than 60% or greater than 70%, or greater than 80%, or greater than 90%, or in the range from 20% to 95%, or in the range from 40% to 90%, or in the range from 60% to 90%, or in the range from 70% to 90% when the Er³⁺ ion concentration is greater than 2.5×10²⁰/cm³.

In embodiments, the quantum yield of the present Er₂O₃-containing glasses is greater than 20% or greater than 40%, or greater than 60% or greater than 70%, or in the range from 20% to 80%, or in the range from 40% to 75%, or in the range from 50% to 75% when the Er³⁺ ion concentration is greater than 5.0×10²⁰/cm³.

In embodiments, the quantum yield of the present Er₂O₃-containing glasses is greater than 20% or greater than 40%, or greater than 60% or greater than 70%, or in the range from 20% to 80%, or in the range from 40% to 80%, or in the range from 50% to 80% when the Er³⁺ ion concentration is greater than 7.5×10²⁰/cm³.

In embodiments, the quantum yield of the present Er₂O₃-containing glasses is greater than 20% or greater than 40%, or greater than 50% or greater than 60%, or in the range from 20% to 70%, or in the range from 40% to 70%, or in the range from 50% to 70% when the Er³⁺ ion concentration is greater than 1.0×10²¹/cm³.

An exemplary fiber was drawn from canes having the composition of Ex. 77 and tested for performance as an amplifier. The exemplary fiber had an outer diameter of 125 μm and a core diameter of 4.2 μm. The core consisted of Er₂O₃-containing glass and was surrounded by a pure silica cladding. The refractive index profile of the exemplary fiber at a wavelength of 850 nm is shown in FIG. 3. The refractive index profile shows the variation of refractive index as a function of radial position (expressed in units of microns (μm)) relative to the centerline of the exemplary fiber (r=0 μm). The peak refractive index of the core is 0.545 greater than the refractive index of the surrounding cladding. The high concentrations of La₂O₃, Al₂O₃, and Er₂O₃ in the core contribute to the high refractive index for the core and a high numerical aperture (NA=0.40) for the exemplary fiber. The high numerical aperture enables good confinement of the pump wavelength (980 nm) in the core when using the exemplary fiber as an amplifier as well as low loss of the optical signal supported by the exemplary fiber when the fiber is bent and deployed in a compact environment.

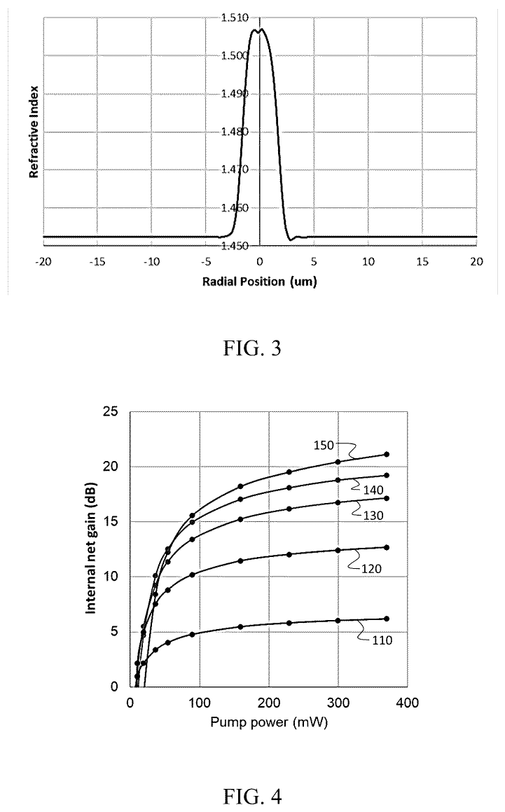

FIG. 4 shows the gain of the exemplary fiber as a function of pump power for different lengths of the exemplary fiber. The pump wavelength was 980 nm and gain was measured for an optical signal with strength −10 dBm at a wavelength of 1550 nm. Absolute gain (in units of dB) was measured for exemplary fibers of length 5 cm (Trace 110), 10 cm (Trace 120), 15 cm (Trace 130), 20 cm (Trace 140), and 30 cm (Trace 150). FIG. 4 demonstrates that high absolute gain (>20 dB) is attainable from the exemplary fiber. The results also indicate that for exemplary fibers of length 5 cm and 10 cm, normalized gain (absolute gain per unit length) above 1.0 dB/cm was achieved with pump powers less than 100 mW. Gain saturation was observed as pump power and length of the exemplary fiber increased. Attainment of high normalized gain at low pump powers and high absolute gain are desirable attributes for fiber amplifiers. The high gain shown in FIG. 4 is enabled by the high Er³⁺ ion concentration in the exemplary fiber in combination with low concentration quenching and low hydroxyl quenching.

Optical fibers with cores made from the Er₂O₃-containing glasses described herein, when pumped at a power of 100 mW at a wavelength of 980 nm and receiving an optical signal having a wavelength of 1550 nm and a strength of −10 dBm, exhibit an absolute gain of the optical signal greater than 5.0 dB, or greater than 10.0 dB, or greater than 15.0 dB, or greater than 20.0 dB, or in the range from 5.0 dB to 25.0 dB, or in the range from 10.0 dB to 25.0 dB, or in the range from 15.0 dB to 25.0 dB.

Optical fibers with cores made from the Er₂O₃-containing glasses described herein, when pumped at a power of 100 mW at a wavelength of 980 nm and receiving an optical signal having a wavelength of 1550 nm and a strength of −10 dBm, exhibit a normalized gain of the optical signal greater than 0.4 dB/cm, or greater than 0.6 dB/cm, or greater than 0.7 dB/cm, or greater than 0.8 dB/cm, or greater than 0.9 dB/cm, or greater than 1.0 dB/cm, or greater than 1.1 dB/cm, or in the range from 0.4 dB/cm to 1.2 dB/cm, or in the range from 0.6 dB/cm to 1.1 dB/cm, or in the range from 0.7 dB/cm to 1.0 dB/cm.

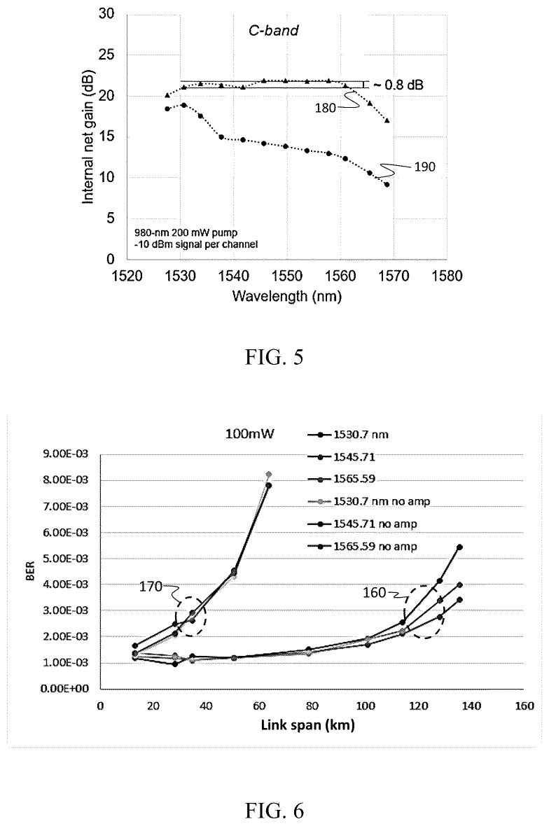

A further advantage of the exemplary fiber is illustrated in FIG. 5, which shows the wavelength dependence of absolute gain as a function of signal wavelength for the C-band. The length of the exemplary fiber was 26 cm. The pump wavelength was 980 nm and the pump power was 200 mW. Signals of strength −10 dBm at multiple wavelengths in the C-band were multiplexed with the pump beam. The results of measurements of absolute gain are shown as Trace 180 in FIG. 5. A noteworthy observation is uniformity of absolute gain as a function of wavelength between signal wavelengths of 1530 nm and 1560 nm. As seen in FIG. 5, the variation in absolute gain (defined as the difference between the maximum absolute gain observed between 1530 nm and 1560 nm and the minimum absolute gain observed between 1530 nm and 1560 nm) is approximately 0.8 dB. For comparative purposes. the variation in absolute gain of a typical commercial Er₂O₃-doped amplifier fiber (Corning ER 1550C3 LC) is shown as Trace 190. The commercial fiber shows a variation in absolute gain of approximately 7.0 dB between 1530 nm and 1560 nm.

Optical fibers with cores made from the Er₂O₃-containing glasses described herein, when configured to a length of 26 cm, pumped at a power of 200 mW at a wavelength of 980 nm and receiving an optical signal comprising a plurality of wavelengths in the range from 1530 nm to 1560 nm with each of the plurality of wavelengths having a strength of −10 dBm, exhibit a variation in absolute gain of the optical signal over the wavelength range from 1530 nm to 1560 nm less than 5.0 dB, or less than 4.0 dB, or less than 3.0 dB, or less than 2.0 dB, or less than 1.0 dB, or in the range from 0.5 dB to 5.0 dB, or in the range from 0.6 dB to 4.0 dB, or in the range from 0.6 dB to 3.0 dB, or in the range from 0.7 dB to 2.5 dB, or in the range from 0.7 dB to 2.0 dB, or in the range from 0.7 dB to 1.5 dB.

FIG. 6 shows the raw bit error ratio (BER) of a commercial 400G ZR coherent transmission signal (16 QAM 400G) at wavelengths of 1530.7 nm, 1545.71 nm, and 1565.59 nm as a function of fiber span length with (Traces 160) and without (Traces 170) amplification using the exemplary fiber. Pumping occurred at a wavelength of 980 nm and a power of 100 mW. To meet a preferred commercial standard, it is desirable for the raw bit error ratio to be less than 0.007. Traces 170 indicate that when an amplifier is not used, the bit error ratio exceeds 0.007 for fiber span lengths above about 60 km for all three wavelengths. Inclusion of an amplifier utilizing the exemplary fiber extends the length of fiber span capable of maintain a bit error ratio less than 0.007 to approximately 140 km. Extension of the fiber span length capable of meeting the bit error ratio standard enables greater flexibility in configuring and distributing data centers and data center interconnects.

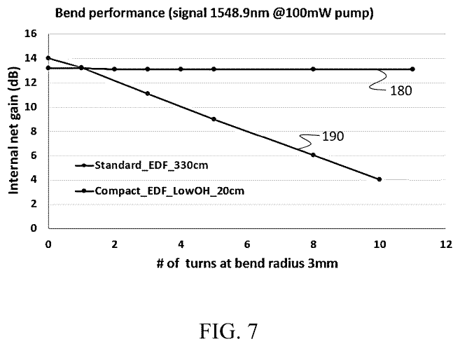

FIG. 7 shows the bend performance of the exemplary fiber (Trace 180) and a comparative commercial fiber (Trace 190) at a signal wavelength of 1548.9 nm upon pumping at 980 nm at a pump power of 100 mW. Bend performance is assessed as the loss in absolute gain of the signal as a function of the number of turns of the fiber about a spool having a bend radius of 3.0 mm. The comparative commercial fiber exhibits a decrease in absolute gain of about 1 dB/turn at a bend radius of 3 mm, while the exemplary fiber exhibited essentially no decrease in absolute gain upon winding at a bend radius of 3 mm. The comparative commercial fiber has a significantly lower Er³⁺ concentration than the exemplary fiber and thus requires a significantly longer length than the exemplary fiber to achieve a particular gain in the initial linear (unbent) configuration (330 cm vs. 20 cm for an absolute gain of 13-14 dB as shown in FIG. 9). The longer required length for the comparative commercial fiber means that a greater number of turns is needed to deploy the comparative fiber in a compact installation environment. Based on the results of FIG. 9, the gain in the comparative commercial fiber would be extinguished after about 15 turns, which corresponds to only about 28 cm of the 330 cm length. As a result, the comparative commercial fiber is unsuitable for use in compact deployment environments. The high signal loss upon bending of the comparative commercial fiber is due at least in part to the low Er₂O₃ doping level of the comparative commercial fiber relative to the exemplary fiber. Low Er₂O₃ doping contributes to a lower refractive index for the core of the comparative commercial fiber relative to the exemplary fiber and accordingly to lower confinement of the optical signal in the core and greater losses upon bending. The high La₂O₃, Al₂O₃, and Er₂O₃ concentrations of the exemplary fiber result in tighter confinement of the optical signal in the core of the exemplary fiber and mitigate bending losses of the optical signal. As shown in FIG. 9, essentially no loss in optical signal after 10 turns, at which point it is completely wrapped around the spool.

Optical fibers with cores made from the Er₂O₃-containing glasses described herein, when pumped at 980 nm at a power of 100 mW and receiving an optical signal having a wavelength of 1548.9 nm and a strength of −10 dBm exhibit a bend loss of the optical signal less than 0.50 dB/turn, or less than 0.25 dB/turn, or less than 0.15 dB/turn, or less than 0.10 dB/turn, or less than 0.05 dB/turn, or less than 0.03 dB/turn, or less than 0.01 dB/turn, or in the range from 0.01 dB/turn to 0.50 dB/turn, or in the range from 0.01 dB/turn to 0.25 dB/turn, or in the range from 0.01 dB/turn to 0.15 dB/turn, or in the range from 0.01 dB/turn to 0.10 dB/turn, or in the range from 0.03 dB/turn to 0.50 dB/turn, or in the range from 0.03 dB/turn to 0.25 dB/turn, or in the range from 0.03 dB/turn to 0.15 dB/turn, or in the range from 0.03 dB/turn to 0.10 dB/turn, or in the range from 0.05 dB/turn to 0.50 dB/turn, or in the range from 0.05 dB/turn to 0.25 dB/turn, or in the range from 0.05 dB/turn to 0.15 dB/turn, or in the range from 0.05 dB/turn to 0.10 dB/turn upon bending at a bend radius of 3.0 mm.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or description that the steps are to be limited to a specific order, it is no way intended that any particular order be inferred.

It will be apparent to those skilled in the art that various modifications and variations can be made without departing from the spirit or scope of the illustrated embodiments. Since modifications, combinations, sub-combinations, and variations of the disclosed embodiments that incorporate the spirit and substance of the illustrated embodiments may occur to persons skilled in the art, the description should be construed to include everything within the scope of the appended claims and their equivalents.

What is claimed is:

1. A glass having a composition comprising:
66.0-95.0 mol. % SiO₂;
10.0-30.0 mol. % Al₂O₃;
0.0-2.0 mol. % B₂O₃;
0.0-20.0 mol. % Na₂O;
0.0-4.0 mol. % ZnO;
0.0-20.0 mol. % La₂O₃;
0.0-20.0 mol. % Y₂O₃;
0.0-3.5 mol. % Yb₂O₃;
0.1-5.0 mol. % Er₂O₃;
0.0-7.0 mol. % F;
wherein the composition satisfies the conditions:
$$1. \leq \frac{{Al}_{2} {O}_{3}}{{Y}_{2} {O}_{3} + {La}_{2} {O}_{3} + {Gd}_{2} {O}_{3} + {Er}_{2} {O}_{3} + {Yb}_{2} {O}_{3} + {Lu}_{2} {O}_{3}} \leq 20.$$
$$0.1 \leq {Y}_{2} {O}_{3} + {La}_{2} {O}_{3} + {Gd}_{2} {O}_{3} + {Yb}_{2} {O}_{3} + {Lu}_{2} {O}_{3} \leq 20. .$$

2. The glass of claim 1, wherein the composition comprises:
0.3-5.0 mol. % Er₂O₃.

3. The glass of claim 1, wherein the composition satisfies the condition:
$$2.5 \leq {Y}_{2} {O}_{3} + {La}_{2} {O}_{3} + {Gd}_{2} {O}_{3} + {Yb}_{2} {O}_{3} + {Lu}_{2} {O}_{3} \leq 20. .$$

4. The glass of claim 1, wherein the glass has a β_{OH} less than 0.100/mm.

5. The glass of claim 1, wherein when excited at 980 nm, the glass exhibits a quantum yield of ⁴I_{13/2}→⁴I_{15/2} emission greater than 40%.

6. An optical fiber comprising a core and a cladding, the core comprising the glass of claim 1, the cladding surrounding and directly adjacent the core, the cladding comprising silica glass.

7. The optical fiber of claim 6, wherein when pumped at 980 nm at a power of 100 mW and receiving an optical signal having a wavelength of 1550 nm and a strength of −10 dBm, the optical fiber exhibits a normalized gain of the optical signal greater than 0.6 dB/cm.

8. A glass having a composition comprising:
66.0-87.0 mol. % SiO₂;
3.0-30.0 mol. % Al₂O₃;
0.0-25.0 mol. % Na₂O;
0.0-2.0 mol. % ZnO;
0.0-25.0 mol. % La₂O₃;
0.0-25.0 mol. % Y₂O₃;
0.0-3.5 mol. % Yb₂O₃;
0.1-5.0 mol. % Er₂O₃;
wherein the composition satisfies the condition:
$$1.1 \leq \frac{{Al}_{2} {O}_{3}}{\begin{matrix}{Y}_{2} {O}_{3} + {La}_{2} {O}_{3} + {Gd}_{2} {O}_{3} + {Yb}_{2} {O}_{3} + {Lu}_{2} {O}_{3} + {Li}_{2} O + {Na}_{2} O \\ + {K}_{2} O\end{matrix}} \leq 11. .$$

9. The glass of claim 8, wherein the composition comprises:
0.3-5.0 mol. % Er₂O₃.

10. The glass of claim 8, wherein the composition satisfies the condition:
$$3. \leq \frac{{Al}_{2} {O}_{3}}{\begin{matrix}{Y}_{2} {O}_{3} + {La}_{2} {O}_{3} + {Gd}_{2} {O}_{3} + {Yb}_{2} {O}_{3} + {Lu}_{2} {O}_{3} + {Li}_{2} O + {Na}_{2} O \\ + {K}_{2} O\end{matrix}} \leq 11. .$$

11. The glass of claim 8, wherein when excited at 980 nm, the glass exhibits a quantum yield of ⁴I_{13/2}→⁴I_{15/2} emission greater than 40%.

12. An optical fiber comprising a core and a cladding, the core comprising the glass of claim 8, the cladding surrounding and directly adjacent the core, the cladding comprising silica glass.

13. The optical fiber of claim 12, wherein when pumped at 980 nm at a power of 100 mW and receiving an optical signal having a wavelength of 1550 nm and a strength of −10 dBm, the optical fiber exhibits an absolute gain of the optical signal greater than 10.0 dB.

14. A glass having a composition comprising:
61.0-95.0 mol. % SiO₂;
0.0-30.0 mol. % Al₂O₃;
0.0-2.0 mol. % B₂O₃;
0.0-30.0 mol. % Na₂O;
0.0-3.0 mol. % ZnO;
0.0-30.0 mol. % La₂O₃;
0.0-30.0 mol. % Y₂O₃;
0.0-10.0 mol. % Yb₂O₃;
0.5-10.0 mol. % Er₂O₃;
0.0-7.0 mol. % F;
wherein the composition satisfies the conditions:
$$0. \leq \frac{{Al}_{2} {O}_{3}}{{Y}_{2} {O}_{3} + {La}_{2} {O}_{3} + {Gd}_{2} {O}_{3} + {Er}_{2} {O}_{3} + {Yb}_{2} {O}_{3} + {Lu}_{2} {O}_{3}} \leq 30.$$
$$0.6 \leq \frac{{Y}_{2} {O}_{3} + {La}_{2} {O}_{3} + {Gd}_{2} {O}_{3} + {Yb}_{2} {O}_{3} + {Lu}_{2} {O}_{3}}{{Er}_{2} {O}_{3}} \leq 30.$$
$$1. \leq {Li}_{2} O + {Na}_{2} O + {K}_{2} O \leq 30. .$$

15. The glass of claim 14, wherein the composition comprises:
2.0-10.0 mol. % Er₂O₃.

16. The glass of claim 14, wherein the composition satisfies the condition:
$$0.1 \leq \frac{{Al}_{2} {O}_{3}}{{Y}_{2} {O}_{3} + {La}_{2} {O}_{3} + {Gd}_{2} {O}_{3} + {Er}_{2} {O}_{3} + {Yb}_{2} {O}_{3} + {Lu}_{2} {O}_{3}} \leq 30.$$

17. The glass of claim 14, wherein the composition satisfies the condition:
$$2.5 \leq \frac{{Y}_{2} {O}_{3} + {La}_{2} {O}_{3} + {Gd}_{2} {O}_{3} + {Yb}_{2} {O}_{3} + {Lu}_{2} {O}_{3}}{{Er}_{2} {O}_{3}} \leq 30.$$

18. The glass of claim 14, wherein when excited at 980 nm, the glass exhibits a quantum yield of ⁴I_{13/2}→⁴I₁₅/2 emission greater than 40%.

19. An optical fiber comprising a core and a cladding, the core comprising the glass of claim 14, the cladding surrounding and directly adjacent the core, the cladding comprising silica glass.

20. The optical fiber of claim 19, wherein when configured to a length of 26 cm, pumped at 980 nm at a power of 200 mW and receiving an optical signal comprising a plurality of wavelengths in the range from 1530 nm to 1560 nm with each of the plurality of wavelengths having a strength of −10 dBm, the optical fiber exhibits a variation in an absolute gain of the optical signal over the wavelength range of less than 4.0 dB.
